(19) United States
(12) Patent Application Publication
(10) Pub. No.: US 2009/0035579 A1
(43) Pub. Date: Feb. 5, 2009

(54) Solid particles, method and device for the production thereof

(75) Inventors: Gerhard Coufal, Leonding (AT); Udo Muster, Salzburg (AT)

Correspondence Address: THE WEBB LAW FIRM, P.C., 700 KOPPERS BUILDING, 436 SEVENTH AVENUE, PITTSBURGH, PA, 15219, US

(73) Assignees: AMI-Agrolinz Melamine International GMBh, Linz (AT); Treibacher Industrie AG, Althofen (AT)

(21) Appl. No.: 11/918,767

(22) PCT Filed: Apr. 18, 2006
(86) PCT No.: PCT/EP2006/003721

§ 371 Date: Oct. 18, 2007

(30) Foreign Application Priority Data
Apr. 18, 2005 (DE) 102005018949.0
Dec. 19, 2005 (AT) A 2026/2005

(51) Int. Cl. B29B 9/12; B29B 9/16; B28B 1/54

(52) U.S. Cl. 428/403; 264/5; 428/402; 425/10

(57) ABSTRACT

The invention relates to solid particles and to a method for the production thereof from a flowable starting material and a solid part, wherein the flowable starting material is split into droplets which are introduced along a trajectory into a solidification liquid in which they are solidified in the form of the solid particles. The invention is characterized by the use of solidification liquid and, if the flowable starting material contains actinide oxide, the solidification liquid steadily flows, thereby making it possible to produce solid particles having a greater sphericity and a narrow particle sized distribution.

The present invention relates to a method and a device for producing solid particles from a starting material that is capable of flow, wherein the starting material that is capable of flow is dropletized and the drops are introduced along a movement track into a solidification liquid in which they are solidified to form the solid particles. The invention further relates to solid particles having high sphericity, in particular urea particles, and particles made of a ceramic material.

A method of the type mentioned at the outset is disclosed by U.S. Pat. No. 4,436,782. This document relates to pelletizinq an oligomeric polyethylene terephthalate to form pellets.

DE-A 100 19 508 A1 discloses a method and a device for forming molten drops of precursors of thermoplastic polyesters and copolyesters.

Atomization and spray methods are currently the predominant methods for producing spherical micro-particles. In all of these methods a particle collective is obtained having a disadvantageously very broad distribution of diameter, mass and density. In addition, the particles produced usually exhibit low roundness and/or sphericity. In addition, in the case of spraying, and in particular atomization, firstly only very small particles, and secondly only particles very different in their shape and size, can be produced using these methods.

Further methods of the prior art for producing spherical particles are pelletizing methods. In these, for example ceramic oxides are mixed with a ceramic binder and shaped in classical pelletizing methods, for example using pelleters to form round particles (for example EP 26 918, EP 1136464 A2). Relatively large particles of approximately 3-10 mm are produced by pressing methods in rubber matrices.

Spherical particles made of stabilized zirconium oxides having a CeO₂ content of less than 30% by mass have been used recently industrially as milling bodies and, on account of their outstanding material properties, act as economically interesting alternative materials to known stabilized zirconium oxides of CaO, MgO or Y₂O₃. On use of the spherical milling bodies in modern high-performance stirred ball mills for wet comminution, a narrow distribution of diameter, mass and density is technically advantageous.

Precisely in the case of wet comminution using modern high-performance mills, increasingly high peripheral velocities and consequently specific energy inputs are transmitted from the stirrer element to the milling bodies. The use of these milling technologies permits grinding of products to the submicron and nanometer range. Conversely, however, corresponding qualitative preconditions must be made of the milling bodies which are found in very uniform and high-density materials having very narrow diameter, density and mass distributions, since by this means a very homogeneous force transmission can be effected from the milling body to the milling material, and thus the milling results with respect to particle fineness and particle distribution of the milling material and also with respect to abrasion of the mill and the milling body can be significantly improved.

A known method for producing spherical microparticles as milling bodies are, for example, drop production methods. In these, for production of magnesium-stabilized zirconium oxides as milling bodies in the shaping step, an aqueous suspension of the oxides which were admixed with a ceramic binder is dripped through a nozzle dropwise into a chemically hardening solution. In EP 0 677 325 A1, dripping an aqueous suspension of the oxides ZrO₂ and Mg(OH)₂ together with a ceramic binder into a chemically hardening ion-exchange solution is described. In DE 102 17 138 A1, a dropletizing method for actinoid oxides is described.

In the prior art, in addition particulate ureas and urea compounds are widely known. They are principally used in the agricultural industry where they are used as fertilizer (for example JP 2002114592, U.S. Pat. No. 3,941,578, JP 8067591).

With respect to their diameter and their particle size distribution, the known urea particles differ fundamentally. For instance, urea particles are known which have diameters in the μm range, for example as described in U.S. Pat. No. 4,469,648. However, the particle diameters are usually in the mm range, as described in EP 1 288 179. Still larger urea granules are disclosed, for example, by CN 1237053.

The abovementioned urea particles are produced in large amounts customarily by prilling or pelletizing methods in which a highly concentrated urea solution or a urea melt is cooled by contact with a gas, for example cold air, and solidified to form particles. A characteristic of these particles produced by these methods is production of a particle collective disadvantageously having very broad diameter and mass distributions. In addition, the particles produced also exhibit corresponding deviations in their geometry, that is to say the particles have a broad particle size distribution and insufficient roundness or sphericity for certain applications.

For certain applications, namely always when very accurate stoichiometric metering of the urea particles is of importance, this is disadvantageous. For these applications high sphericity and a very narrow particle size, mass and density distribution are critical.

It is therefore an object of the present invention to provide a method and a device for producing solid particles which permits the particles to be produced having a high sphericity (particle shape) and narrow particle size, mass and density distributions. In addition, the object is to produce solid particles having particular properties, that is urea particles and ceramic particles.

In the method a solidification liquid is selected. In the event that the starting material that is capable of flow comprises ceramic particles, it is advantageous if a flowing solidification liquid is used. It is advantageous if the surface tension of the solidification liquid is less than that of the starting material; this means σ_{solidification liquid}<σ_{drops, starting material that is capable of flow}. Particularly, a surface tension of the solidification liquid of less than 50 mN/m, in particular less than 30 mN/m, ensures transfer of the drops of the starting material that is capable of flow into the solidification liquid in which damage or even destruction of the drops on phase transition are avoided.

In addition it is advantageous if, between solidification liquid and the starting material that is capable of flow, there is a polarity difference as large as possible, which can be defined via the interfacial surface tension. Interfacial surface tensions between 25 and 50 mN/m are advantageous, in particular between 30 mN/m, very particularly between 35 and 50 mN/m.

A suitable starting material that is capable of flow is especially a melt, in particular a urea-containing melt or a polymer melt or a thermally unstable melt and, as solidification liquid, a coolant, in particular a fluid which has both a lower surface tension than the starting material that is capable of flow and also an opposite polarity to the starting material that is capable of flow. In the case of urea-containing melts, this is preferably a nonpolar fluid. A fluid is taken to mean a material that is capable of flow or a composition of matter, in particular a liquid or a liquid mixture.

In one embodiment of the method according to the invention, however, as starting material, use can also be made of a suspension that is capable of flow which contains a ceramic material and a binder and which, for solidification, is introduced into a flowing or else non-flowing, in particular in the case of non-flowing, into a static, solidification liquid in which chemical hardening is brought about.

For producing solid particles of high sphericity, a correspondingly high polarity difference is advantageous, characterized by a correspondingly high interfacial surface tension between the drops of the starting material that is capable of flow and the solidification liquid in combination with solidification adjusted in a targeted manner of the drops produced of the starting material that is capable of flow to give the solid particles.

In this case the interfacial surface tension and the polarity difference are defined as follows:

As a measure of the size of the polarity difference between the starting material that is capable of flow and the solidification liquid, use is made of the interfacial surface tension. Since the values of interfacial surface tension are very difficult to determine experimentally, they are determined via the surface tensions which are firstly readily determinable experimentally, and secondly are sufficiently well documented in the relevant literature. For this, the surface tension of a medium phase (σ) is described as the sum of the nonpolar interactions (σ_{D}, London dispersion forces) and the polar interactions (σ_{P}, polar forces). The index i refers to the respective phase and the index ij to a phase boundary.

σᵢ=σ_{D,i}+σ_{p,i}
σᵢ surface tension of the medium phase i [mN/m]
σ_{D,i} nonpolar fraction of the surface tension, London fraction [mN/m]
σ_{P,i} polar fraction of the surface tension [mN/m]

Experimentally, the nonpolar and polar fractions of the surface tension are determined via the contact angle method. For instance, for example water at 20° C. exhibits a surface tension (σ_{water}) of 72.8 mN/m having a nonpolar fraction of σ_{D,water} of 21.8 mN/m and a polar fraction of σ_{P,water} of 51.0 mN/m. With the knowledge of the polar and nonpolar fractions of the surface tensions, the interfacial surface tension between two medium phases is defined as follows:

σᵢⱼ=σᵢσⱼ−2*(\sqrt{σ_{D,i}*σ_{D,j}}+\sqrt{σ_{P,i}*σ_{P,j}})
σᵢⱼ interfacial surface tension of the medium phases i and j at the phase boundary, for example starting material that is capable of flow and solidification liquid [mN/m]
σ_{D,i}, σ_{D,j} nonpolar fraction of surface tension of the medium phases i and j [mN/m]
σ_{p,i}, σ_{p,j} polar fraction of surface tension of the medium phases i and j [mN/m]

In general, it is true that at a high value of interfacial surface tension there is a high polarity difference between the two medium phases. The surface tensions and/or interfacial surface tensions are temperature-dependent and in this respect are related to a temperature of 20° C. or, in the case of melts to a characteristic transition temperature (for example melt temperature, glass point) by definition.

The polarity difference between the starting material that is capable of flow and the solidification liquid can alternatively also be described by the contact angle φ between two fluid phases or the wetting angle between a fluid phase and a solid phase.

$$cos ϕ = \frac{{σ}_{i} - {σ}_{ij}}{{σ}_{j}}$$

σᵢⱼ interfacial surface tension of medium phases i and j at the phase boundary, for example starting material that is capable of flow and solidification liquid [mN/m]
σᵢ surface tension of medium phases i, solidification liquid [mN/m]
σⱼ surface tension of medium phases j, starting material that is capable of flow [mN/m]

On account of the opposing interactions or in the case of a correspondingly high polarity difference between drops of the starting material that is capable of flow and the solidification liquid, the smallest phase boundary between the two medium phases forms in support. This is a spherical surface, particularly when the submerged drop remains capable of flow over a sufficiently short time period, in particular in the case of drops from melt, very particularly in the case of urea-containing melt drops. In this case, owing to the heat of crystallization liberated, heat flow in the direction of the phase boundary or in the direction of the temperature gradient is formed. The starting drop first remains, at the characteristic transition temperature (removal of latent heat), sufficiently capable of flow so that advantageous reshaping of the possibly damaged particle to give the spherical particle can be effected. In the case of urea particles (or urea-containing particles), this is shown in the visible change of the transparent appearance of the particle to an opaque appearance.

In the dropletizing of a starting material that is capable of flow based on a ceramic material and of a binder, the polarity difference between the suspension and the solidification liquid can be utilized advantageously, in particular when the solidification liquid consists of two slightly miscible, or immiscible, phases or polarities and/or different densities, so that in particular the nonpolar, less dense and lower surface area phase compared with the starting material that is capable of flow shapes or reshapes the particles that are still capable of flow to form a spherical particle, and subsequently in the denser phase the chemical hardening is effected.

In the dropletizing of a starting material that is capable of flow based on a ceramic material and a binder, in addition the use of a solidification liquid is particularly advantageous, which solidification liquid consists of at least two miscible components of different polarity, wherein the opposing interaction is utilized by the less polar component for forming a spherical particle and by reducing the reaction rate by the less polar component the chemical hardening time can be increased, so that the particle being reshaped to form a spherical particle remains capable of flow over a sufficient time period and is correspondingly chemically hardened in a targeted manner.

In the dropletizing of a starting material that is capable of flow based on a ceramic material and a binder, combining a solidification liquid consisting of two immiscible phases or polarities and/or different densities is very particularly advantageous, so that in particular the nonpolar, less dense and lower surface area phase compared with the starting material that is capable of flow shapes or reshapes the particle to give a spherical particle, since this is still sufficiently capable of flow, and in the denser phase the chemical hardening can be controlled in time by adding a miscible but less polar component.

In one embodiment of the method according to the invention, an interfacial surface tension between the drops of the starting material that is capable of flow and the solidification liquid is set between 25 and 50 mN/m, in particular between 30 and 50 mN/m, and very particularly between 35 and 50 mN/m.

In addition, preferably a solidification liquid is selected in such a manner that the contact angle between the starting material that is capable of flow and the solidification liquid and/or the wetting angle between the hardened starting material and the solidification liquid is >45°, and particularly preferably >90°.

As a solidification liquid, in the case of a polar starting material that is capable of flow, in particular in the case of polar melts, in particular in the case of urea or urea-containing melts, use is made of a nonpolar fluid, in particular an aliphatic high-boiling hydrocarbon, an unsaturated hydrocarbon, an aromatic hydrocarbon, a cyclic hydrocarbon, a halogenated hydrocarbon, and/or hydrocarbons having at least one ester, keto or aldehyde group or a mixture of at least two hydrocarbons, in particular having a mixture of aliphatics or consisting of them.

The object is also achieved by urea particles, a ceramic particle and use thereof and a device for producing the particles.

Further advantageous embodiments in this respect are described in connection with the figures and are the subject matter of subclaims.

The invention will be described in more detail hereinafter with reference to the figures of the drawings of a plurality of examples. In the drawings:

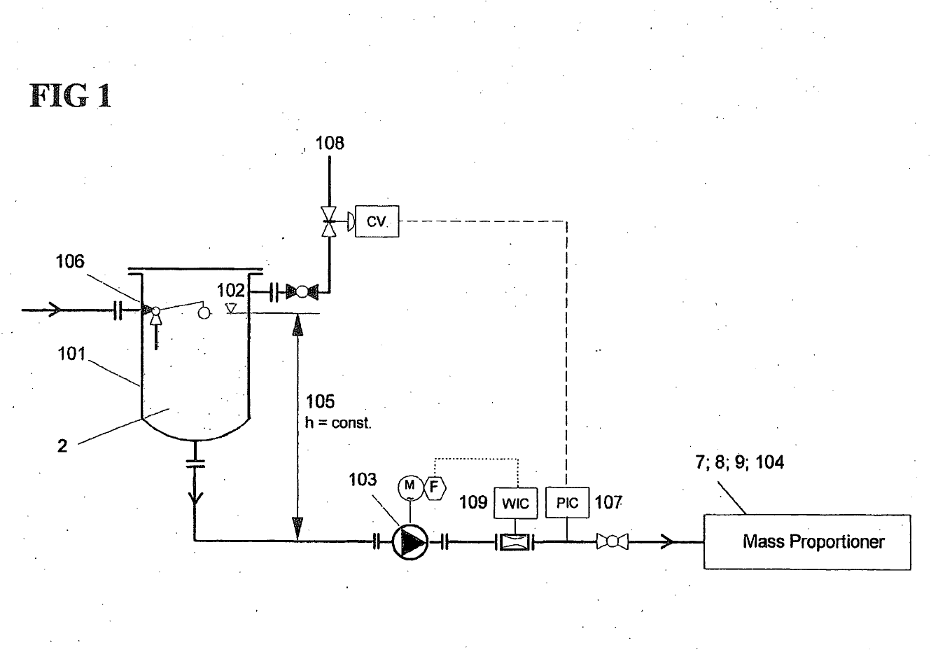

FIG. 1: shows a process flow chart for the open-loop control and/or closed-loop control of a constant mass flow of an embodiment of the method according to the invention and of the device according to the invention;

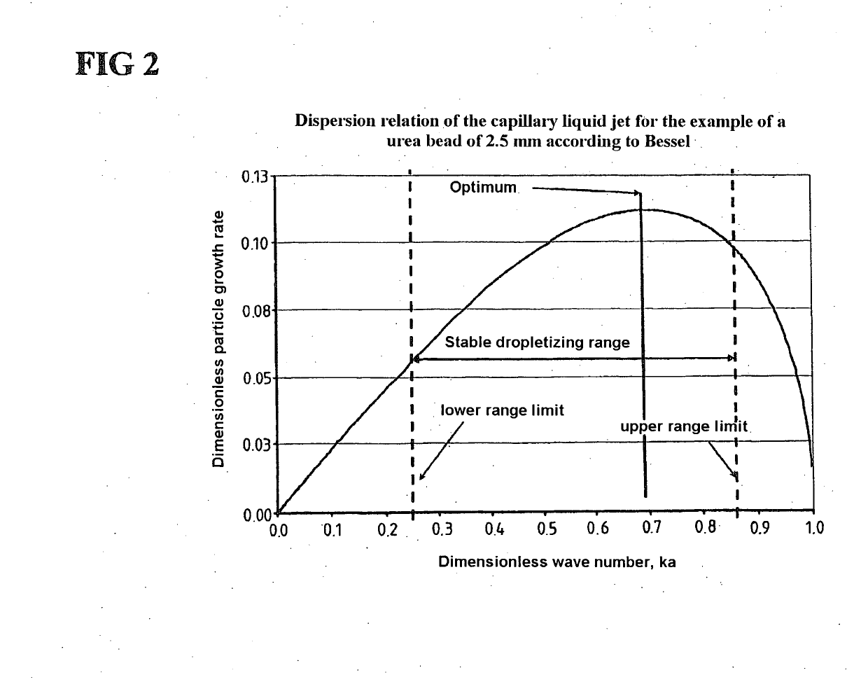

FIG. 2: shows Rayleigh dispersion relation via Bessel functions for the example of production of a urea bead having a diameter of 2.5 mm;

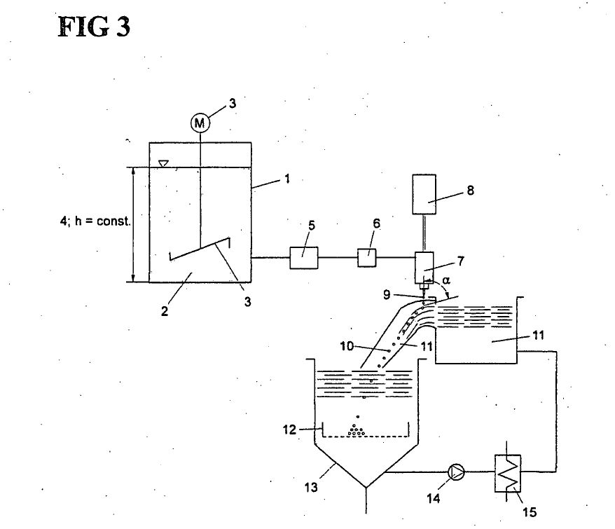

FIG. 3: shows a process flow chart of an embodiment of the method according to the invention (duct channel) and a device according to the invention;

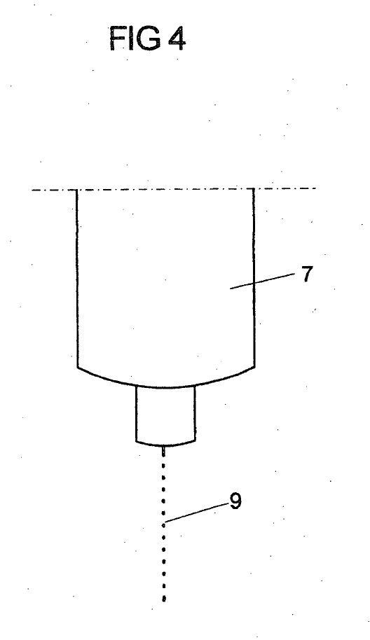

FIG. 4: shows a diagrammatic illustration of a static drop pattern;

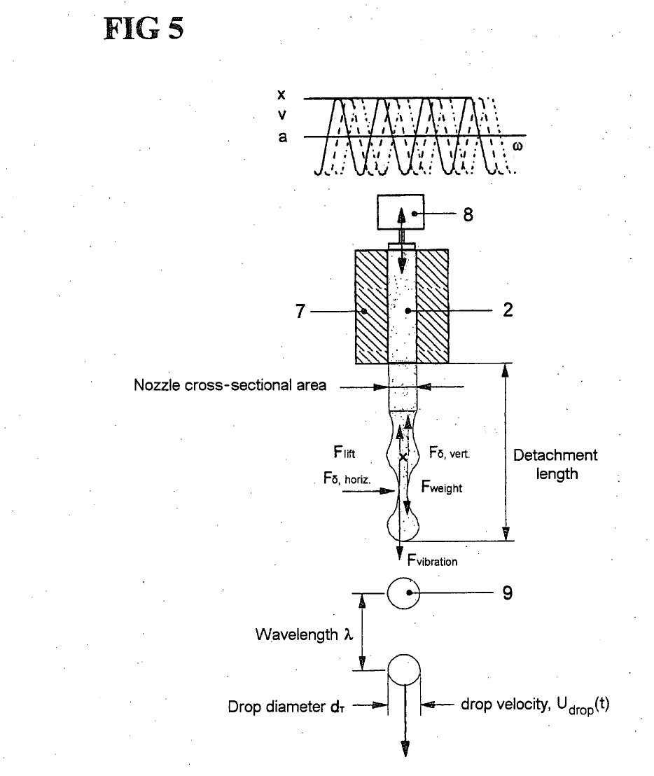

FIG. 5: shows a diagrammatic illustration of dropletizing (mass proportioner) of a laminar jet breakdown with resonance excitation of the starting material that is capable of flow:

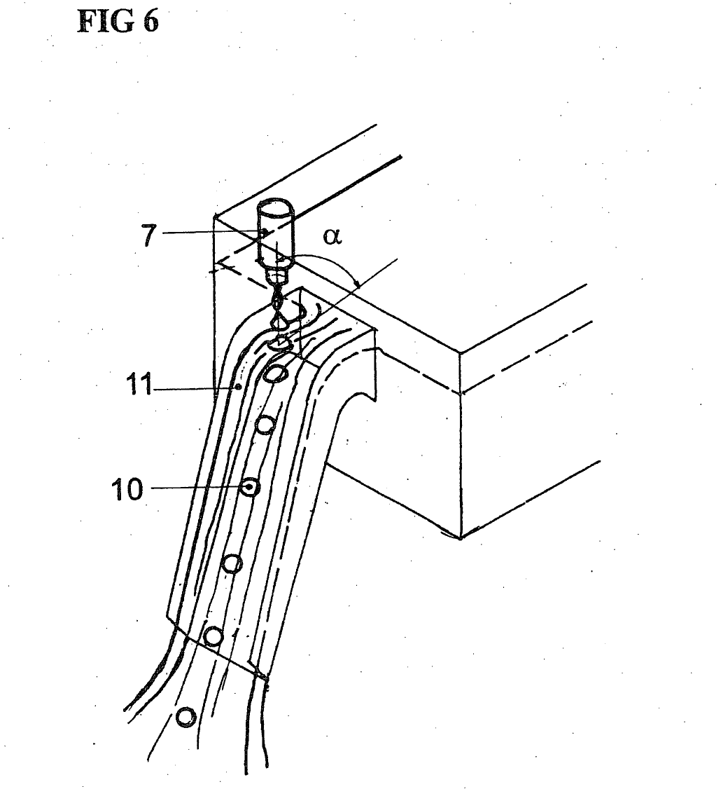

FIG. 6: shows a perspective view of the instillation according to the embodiment of the method of the invention according to FIG. 5 (duct channel);

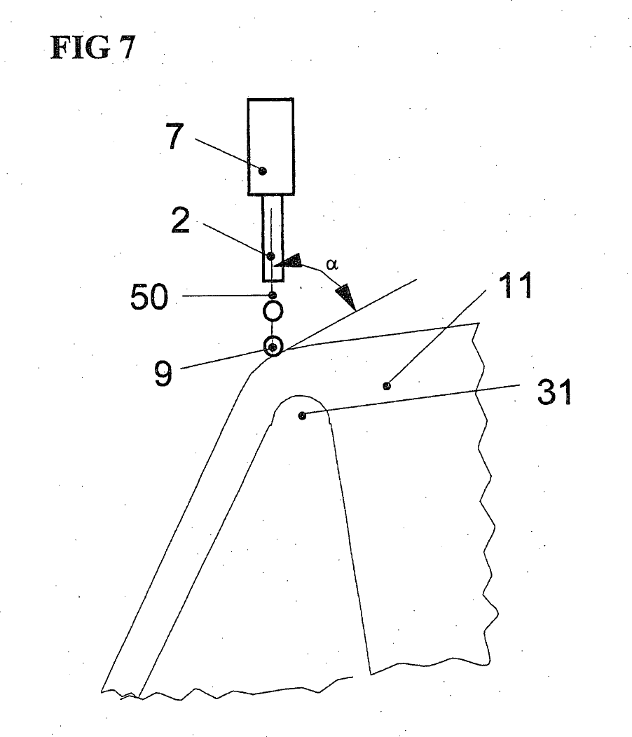

FIG. 7: shows a side view of the instillation according to an embodiment of the method of the invention;

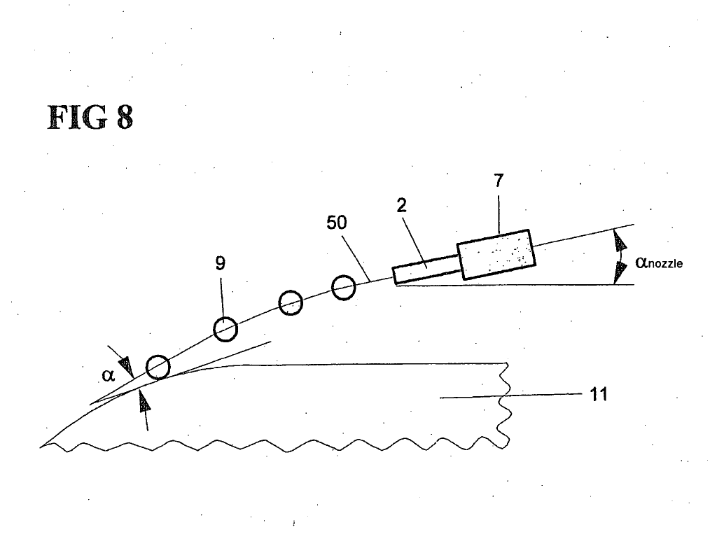

FIG. 8: shows a diagrammatic illustration of the reduction of the relative velocity by changing the angle of incidence by means of a curved movement track;

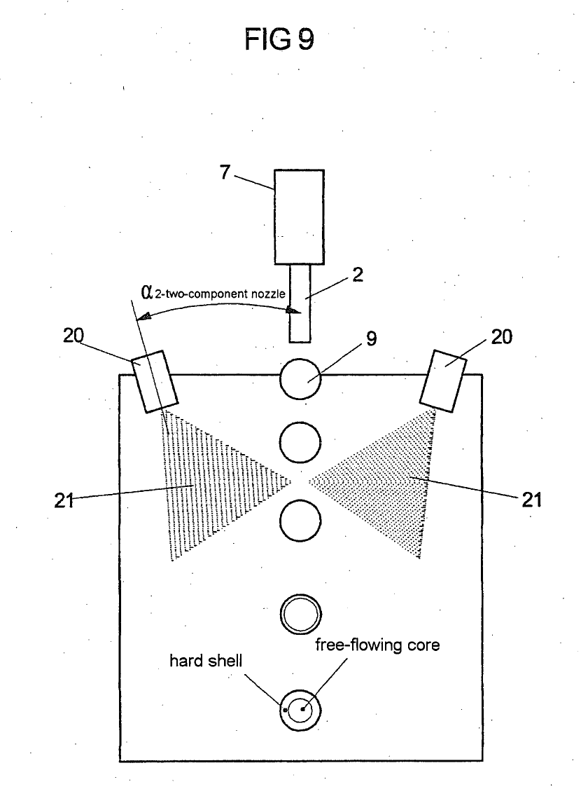

FIG. 9: shows a diagrammatic illustration of precooling by aerosol spraying of a nonpolar fluid for partial hardening of the urea particles during the falling phase, using two-component nozzles;

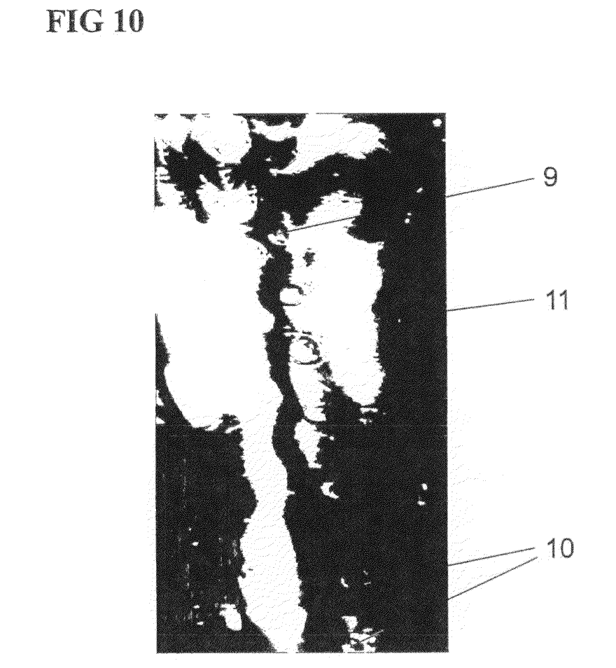

FIG. 10: shows a photographic illustration of formation of a spherical urea particle in a solidification liquid, here a cooling and reshaping and stabilizing liquid;

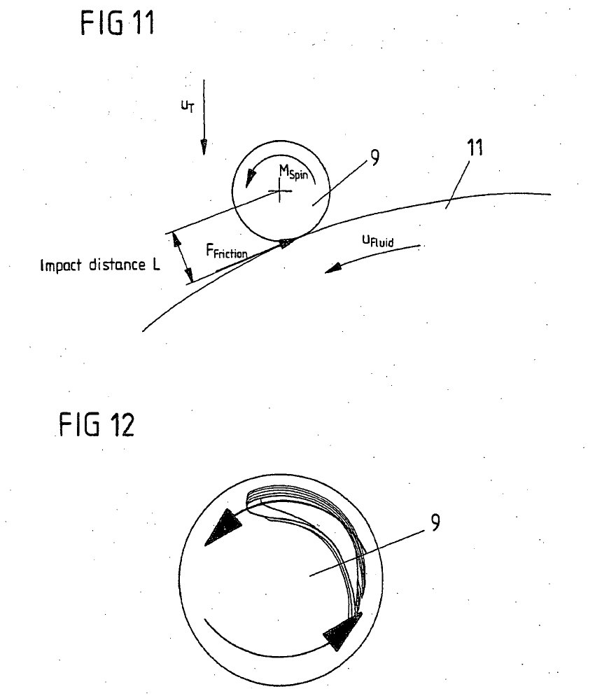

FIG. 11: shows an outline sketch relating to production of spin;

FIG. 12: shows a spatial depiction of a bead which has experienced rotation as a result of a two-dimensional velocity field—stabilization effect;

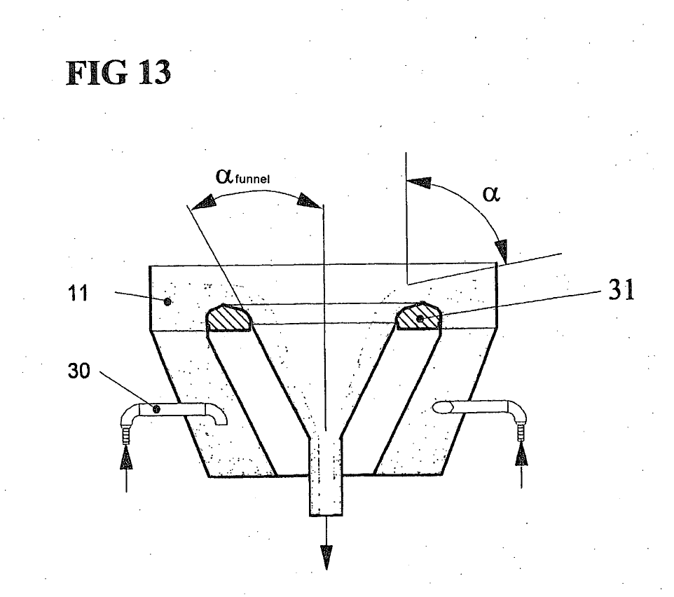

FIG. 13: shows a diagrammatic illustration of an embodiment of the device according to the invention (duct channel funnel with overflow edge);

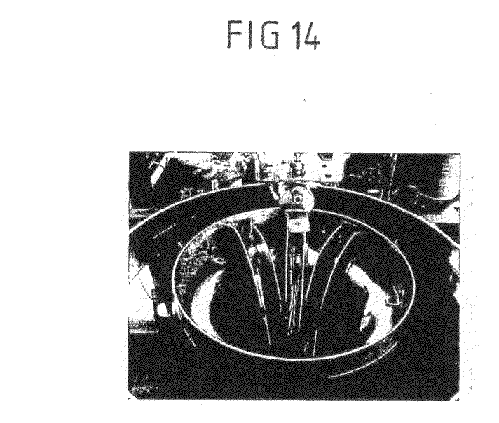

FIG. 14: shows a photographic illustration of a duct funnel of an advantageous design of the device according to the invention according to FIG. 13 (duct channel funnel with overflow edge, 3 ducts);

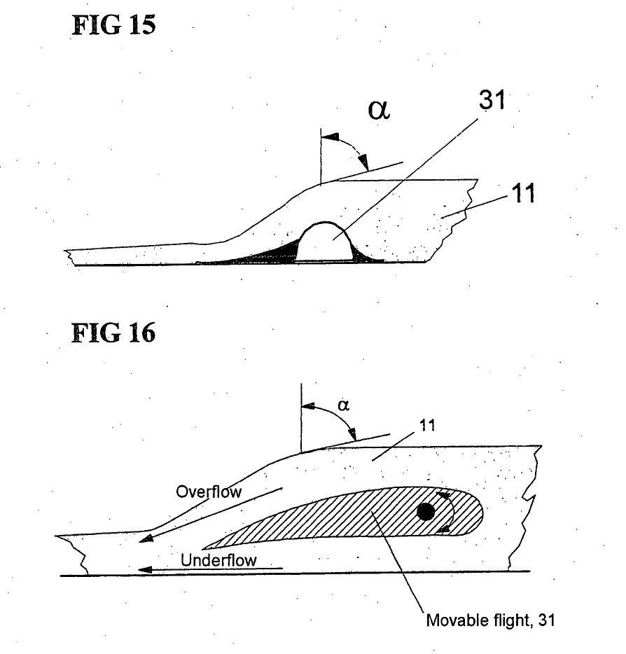

FIG. 15: shows a sectional view of an alternative embodiment of a device according to the invention (duct channel with flow impeder);

FIG. 16: shows a sectional view of an alternative embodiment of a device according to the invention (duct channel with adjustable flow impeder);

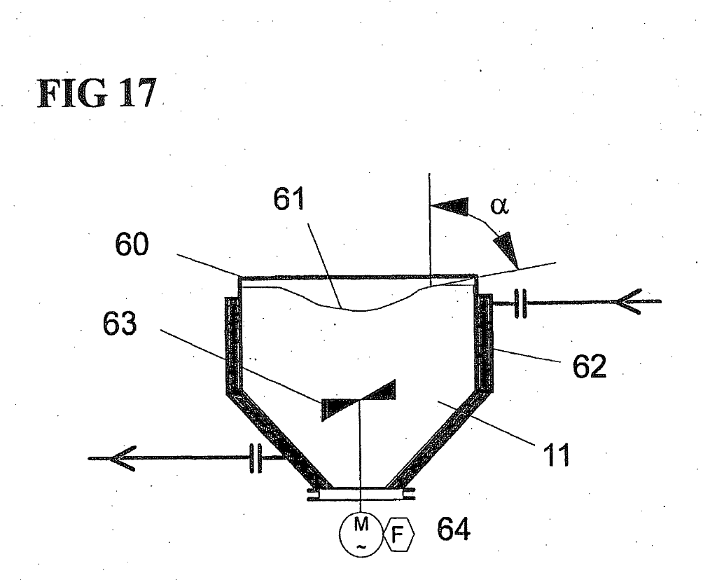

FIG. 17: shows a sectional view of an embodiment of the device according to the invention using rotary flow in the form of a whirlpool;

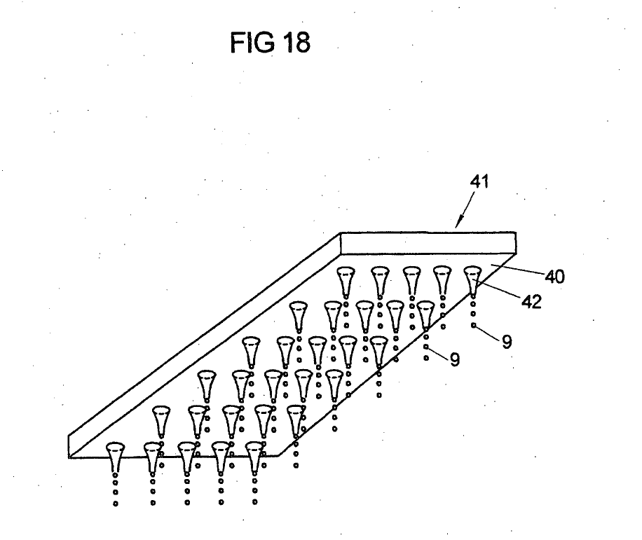

FIG. 18: shows a diagrammatic perspective view of a perforated plate as dripping device;

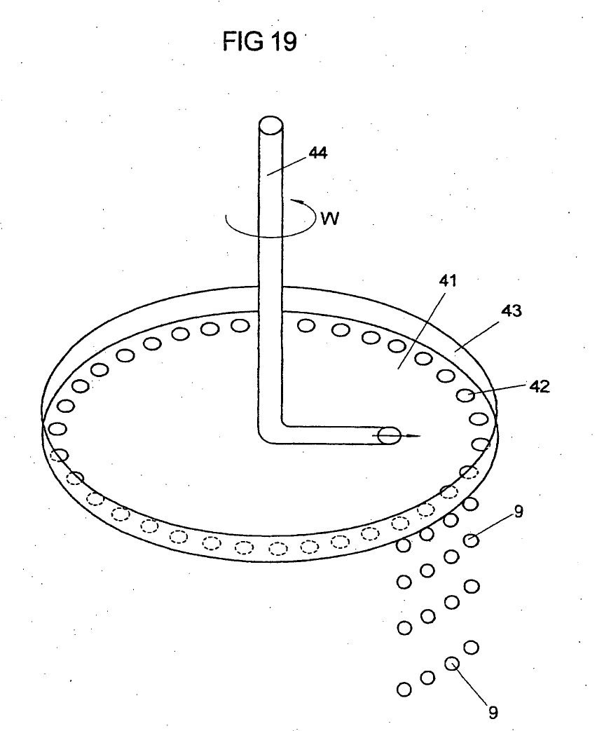

FIG. 19: shows a diagrammatic perspective view of a perforated plate having rotary feed of the starting material that is capable of flow for dripping;

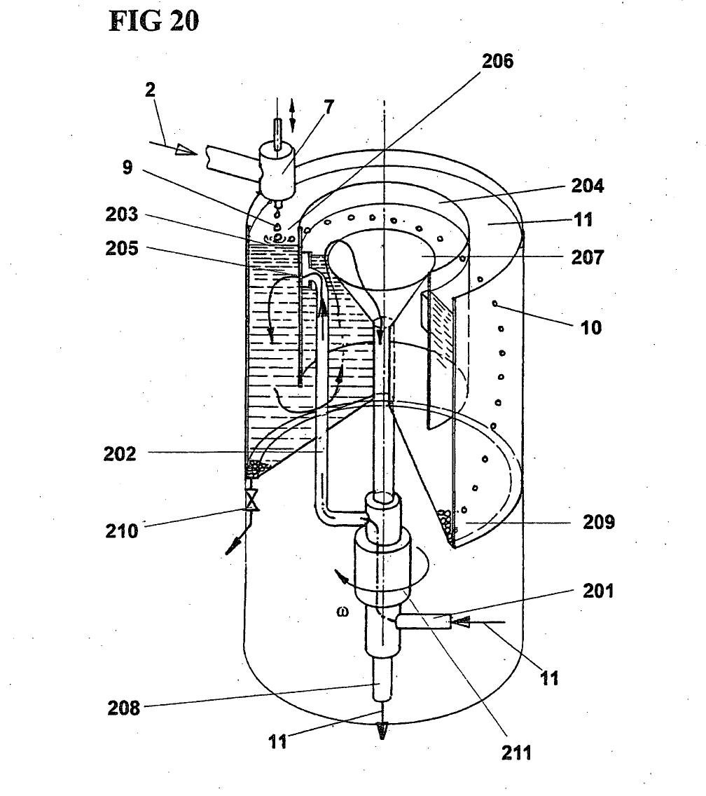

FIG. 20: shows a perspective illustration of a preferred embodiment of the method according to the invention (rotary vessel);

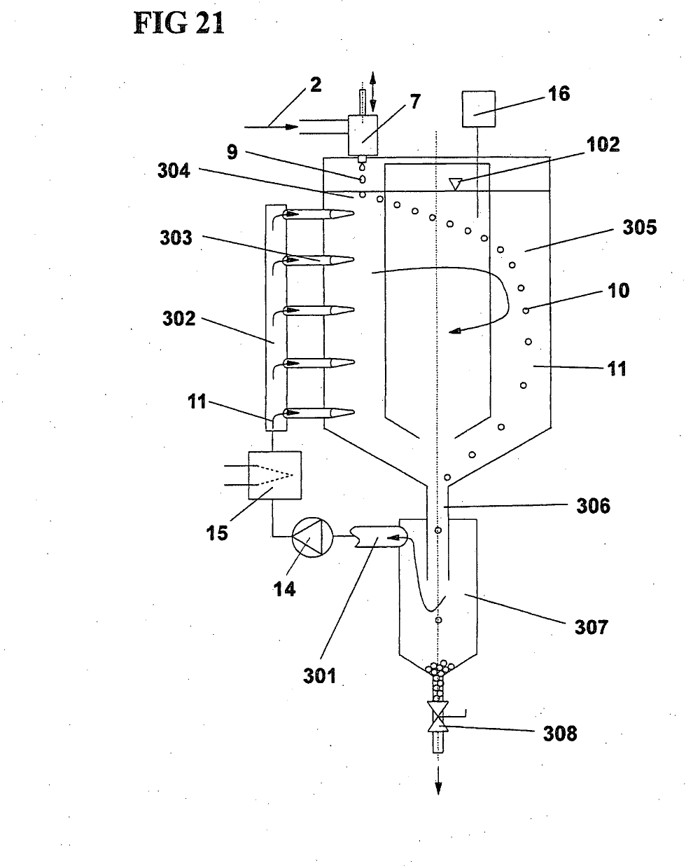

FIG. 21: shows a side view of a preferred embodiment of the method of the invention (spin motion in the stationary annular channel vessel by tangential introduction of the solidification liquid);

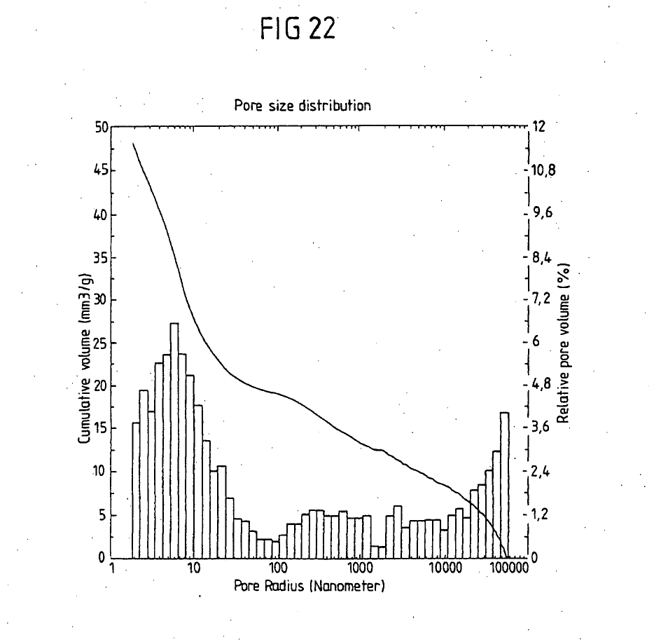

FIG. 22: shows a diagram of the pore size distribution of spherical urea particles—produced by an embodiment of the method according to the invention;

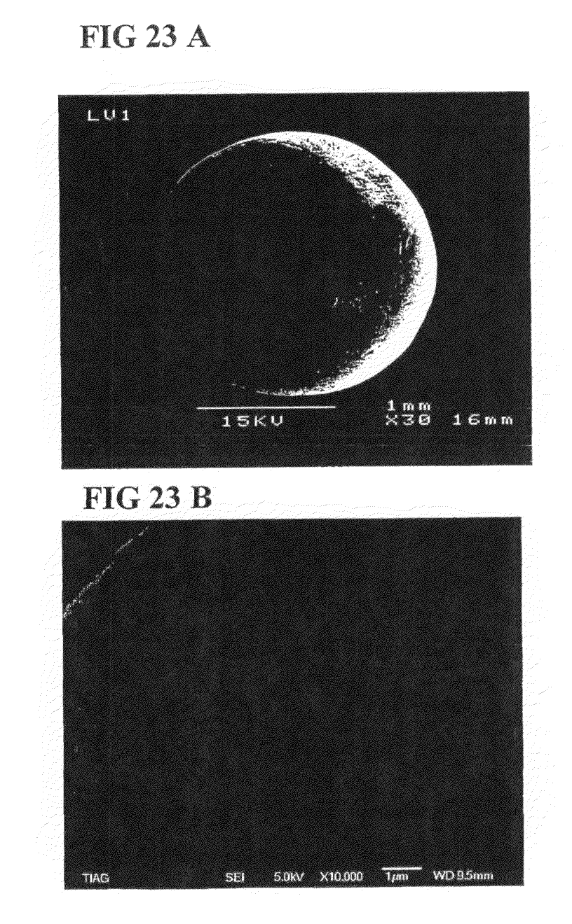

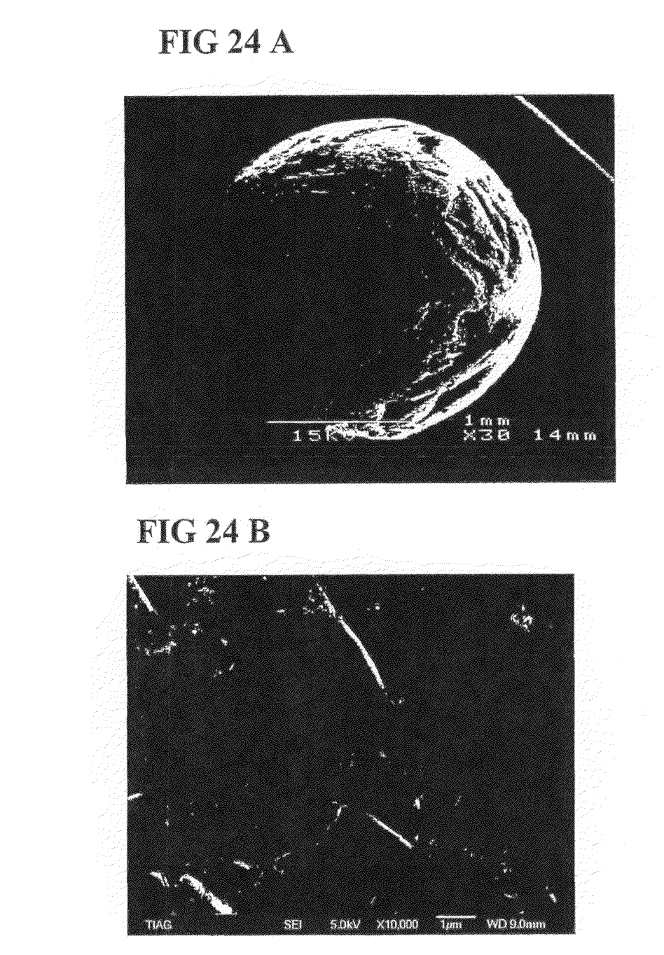

FIG. 23A: shows the SEM of a spherical urea particle (1.8-2.0 mm) produced by an embodiment of the method according to the invention, enlargement: 30 times;

FIG. 23B: shows the SEM of the microstructure of a urea particle (1.8-2.0 mm) produced by an embodiment of the method of the invention according to FIG. 23A enlargement: 10 000 times;

FIG. 24A: shows the SEM of a urea particle (1.8-2.0 mm) produced by conventional prilling units, technical goods, enlargement: 30 times;

FIG. 24B: shows the SEM of the microstructure of a urea particle (1.8-2.0 mm) according to FIG. 24A produced by conventional prilling units, technical goods, enlargement: 10 000 times;

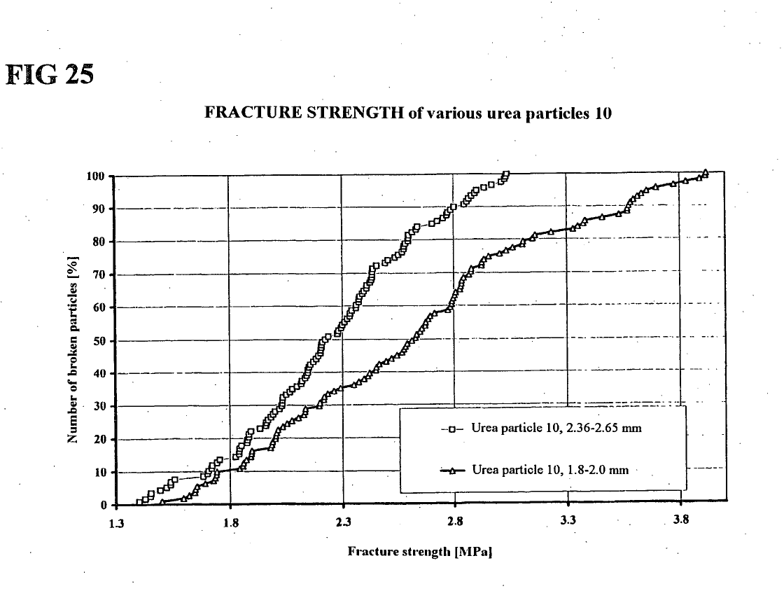

FIG. 25: shows a diagram of the fracture strength distribution of spherical urea particles (10)—produced by an embodiment of the method according to the invention compared with technical goods;

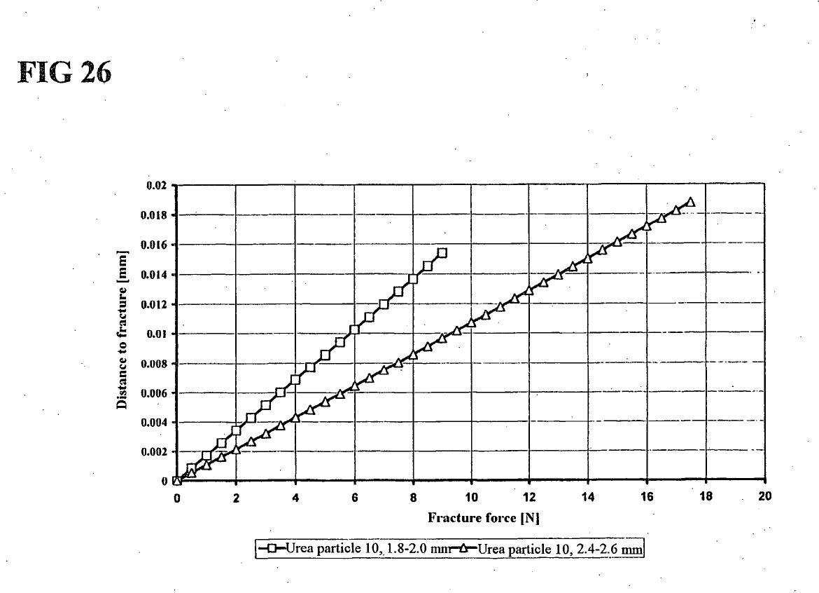

FIG. 26: shows a diagram of the ultimate elongation lines of spherical urea particles (10)—produced by the embodiment of the method according to the invention, compared with technical goods;

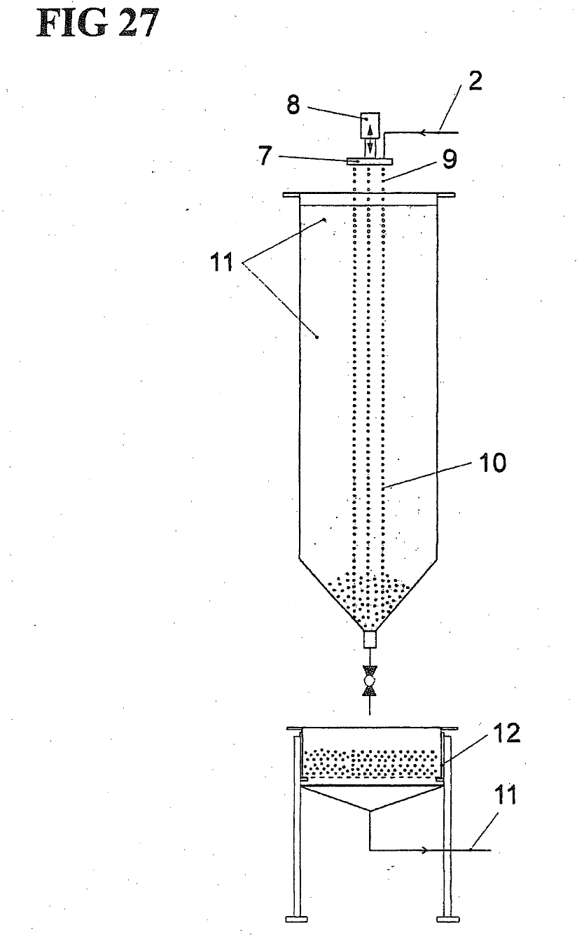

FIG. 27: shows a diagrammatic illustration of a particular embodiment of the method according to the invention for producing spherical solid particles based on ceramic materials by using two immiscible phases of the solidification liquid.

In principle there are different and known methods for dividing a starting material that is capable of flow into individual drops. When the starting material that is capable of flow flows out through a nozzle, capillary or perforated plate, the liquid first forms a jet which breaks down into individual drops as a result of unsteadiness.

Depending on the flow regime prevailing during jet breakdown, a differentiation is made between the following:
dripping
laminar jet breakdown (dropletizing)
wave breakup
turbulent jet breakdown (atomizing, spraying)

To achieve particles having the narrowest possible particle size, mass and density distributions, in particular the flow regime of dripping and of laminar jet breakdown are of interest. In dripping, the outflow velocities approach zero and the flow and frictional forces are negligible.

If the flow velocity is increased, a laminar jet forms over a flow range which can be defined by means of the Reynolds number [Re]. The critical jet Reynolds number [Re_{crit,jet}] defines the transition from laminar flow conditions to turbulent flow conditions or delimits the two flow regimes from one another. The Re_{crit,jet} is a function of the dimensionless number, Ohnesorge [Oh] and over a known inequality relationship; delimits the capillary breakdown (laminar) from the breakdown affected by aerodynamic forces (turbulent). It is recorded that the Re_{crit,jet} is defined firstly by the material properties of the fluid to be dropletized (starting material that is capable of flow) and secondly by the nozzle diameter or hole diameter used and, in contrast to pronounced tubular flows (for example Re_{crit,pipe}=2.320) does not have an absolute value.

Unsteadiness generally leads to the fact that drops 9 of different size are formed. By imposing a mechanical vibration 8, which can be generated in the most varied and known manner, onto the liquid column, the capillary or the ambient air, the formation of drops of equal size can be achieved. The periodic disturbance pinches off the jet at constant intervals. Despite these known precautions, the preconditions must be created which lead to constancy of the mass flow rate and its temperature (density). It is understandable that despite a constant periodic disturbance, with fluctuation of a laminar mass flow and its temperature (density), drops 9 of different sizes would be generated.

For the generation of narrow particle size distributions and in particular mass distributions by laminar jet breakdown, without, and in particular with vibration or resonance excitation, the starting material that is capable of flow 2 is transported under force to the actual mass proportioner 7, 8. In this device the mass flow which is kept constant is, at constant temperature (density), under laminar flow conditions, divided into drops 9 of narrow mass distribution, preferably by applying a periodic disturbance. Between the mass flow [M] kept constant and the diameter generated of the drops [d_{T}], the excitation frequency [f] and the density. [ρ_{fluid}] there is the following relationship:

$$\dot{M} = ( \frac{{d}_{T}^{3} * π}{6} ) * \frac{f}{{ρ}_{Fluid}}$$

M mass flow rate of the fluid [kg/s]
d_{T} diameter of the drop [m]
ρ_{fluid} density of the fluid, starting material that is capable of flow [kg/m³]
f frequency of the periodic disturbance [hz or 1/s]

The density of the starting material that is capable of flow, and in particular the mass flow, is a function of temperature, therefore the dropletizing process is advantageously carried out under the control of a measured defined temperature. At a constant mass flow rate and a defined periodic disturbance of frequency f, and also of known constant temperature (density ρ and other temperature-dependent material properties), a defined diameter d_{T} of the drop 9 is generated.

Setting a constant mass flow rate (see FIG. 1) with forced transport can be effected in the most varied ways, for example
by a pressure difference held constant, either via a technically known pressure regulator 107 by means of a pressure control valve CV or by a defined superimposition of the fluid phase of the starting material that is capable of flow with a pressurizing gas 108,
by exact setting of a hydrostatic height 105 of the starting material that is capable of flow 2 with replenishment of the starting material that is capable of flow 2 with the fluid level 102 being kept constant via a float valve 106,
by a pressure boosting pump 103, in particular a pulse-free pump 103.
or by combinations of the variants listed by way of example.

The mass flow rate is measured according to the coriolis measurement principle, for example, using a mass flow metering instrument 109, the measurement also being used for closed-loop control of the mass flux by rotary speed control of the pump 103. Currently commercially available coriolis sensors have the advantages of simultaneous mass, density, temperature and viscosity measurement, so that all parameters relevant for control of the dropletizing process can be determined and controlled simultaneously.

It has been found that the particle size distribution can be advantageously narrowed when the starting material that is capable of flow is dropletized by exposing a laminar jet of the starting material that is capable of flow 2 to a resonance excitation. In the mass proportioner 7, 8, 104, the jet of the starting material that is capable of flow which is conducted in a laminar fashion and under constant mass, is, in particular by periodic disturbance or disturbance force of frequency f periodically divided or periodically pinched off (see FIG. 5) into drops 9 of equal mass. By imposing this periodic vibration, or in particular this harmonic vibration, of frequency f onto the liquid column, the nozzle (capillary, vibrating perforated plate) or the ambient medium, or by cutting the jet, formation of drops 9 having a narrow mass distribution is advantageously achieved. The imposition of a defined and periodic disturbance force in a mechanical, electromechanical and/or electromagnetic route can proceed via a harmonic vibration system (electromagnet, piezoelectric crystal probe, ultrasonic probe, rotating wire, cutting tool, rod). Drop dividers of these types are known per se.

Between the diameter of the drop (d_{T}) to be produced, which is produced by a periodic disturbance of a mass-defined liquid jet conducted under laminar flow conditions of the starting material that is capable of flow (2) of frequency f, and the diameter of the jet or of the nozzle orifice D_{nozzle}, corresponding to the known relationships of Lord Rayleigh and Weber, via the dimensionless numbers, in particular ka (wave number) and/or ka_{opt,Rayleigh} (optimum Rayleigh wave number) and/or ka_{opt,Weber} (optimum Weber wave number), an optimum excitation frequency for the material system under consideration in each case can be determined and defined. Corresponding to these calculations, a correspondingly stable working range of dropletization appears. This working range for a stable dropletizing process is illustrated for the example of producing spherical urea particles of diameter 2.5 mm in FIG. 2. The validity of these laws of laminar jet breakdown with resonance excitation, in particular in the case of dropletizing urea or urea-containing melts or suspensions of a ceramic material based on CeO₂/ZrO₂ with a binder, can be confirmed via the dimensionless numbers Bond [Bo], Weber [We], Ohnesorge [Oh] and Froude [Fr]. In this identified working range, drop generation can be particularly readily controlled under open-loop and closed-loop conditions, in particular under the premise of constant mass flow rate of the starting material that is capable of flow.

FIG. 3 shows the fundamental structure of an embodiment of the method according to the invention in outline. FIG. 5 then shows a particular embodiment of dropletization in detail.

In FIG. 3, the starting material 2 which is capable of flow and is to be dropletized is transported from a storage vessel 1 to the mass proportioning unit 7 (having a nozzle) with resonance excitation 8 in which the dropletization takes place. The starting material 2, to achieve a phase as homogeneous as possible can be continuously agitated with a stirrer element 3. In an advantageous embodiment, in the storage vessel 1, a constant fluid level 4 is set, in such a manner that a semi-constant inlet pressure acts both on an installed pump 5 and on the mass proportioner 7. The pressure can also be set via a corresponding pressurizing gas superimposition of the fluid level 4.

The starting material 2 is transported via a pump 5 and subsequently via a mass flow meter 6 which operates, for example, by the coriolis measurement principle. In this case the rotary speed of the centrifugal pump 5 is advantageously controlled via the guide variable mass flow rate, in such a manner that a constant mass flow rate to the mass proportioner 7 is set.

The starting material that is capable of flow 2, which here, for example, is transported under force and at constant mass flow rate, is forced through an orifice in the form of a nozzle 7 which is shown here as part of a mass proportioner, under laminar flow conditions. A harmonic vibration (sinus vibration) is superimposed on the jet of starting material that is capable of flow 2 by means of electronically controlled electromagnets 8. The acceleration a of the periodically introduced disturbance force relevant for the detachment process is shifted with respect to the amplitude x of the vibration by the phase π [rad]. The starting material 2 first forms a laminar flowing jet which shortly after the nozzle orifice 7, but with a corresponding spacing from the nozzle, breaks up in accordance with the laws of laminar jet breakup. Owing to the vibration force imposed on the starting material 2, a defined and periodically recurring weakened point is produced in the jet, in such a manner as to produce drops 9 of constantly equal mass (and therefore later particles) having a drop diameter d_{T} (quantity and mass proportioning) which still vibrate. The vibration force is added periodically to the motive force of detachment.

The drops 9 of the starting material that is capable of flow 2 then move along a movement track 50 in the direction of the solidification liquid 11. If no additionally introduced forces, for example aerodynamic forces, act on the drops 9, the drops fall downward under gravity.

This arrangement permits variation of the production of different diameters of solid particles by varying the vibration frequency f, the amplitude x, the nozzle diameter d_{nozzle} and varying the mass flow rate which is to be kept constant. By this arrangement, it is thus possible to produce defined drops 9 in a targeted manner having very narrow density, mass and diameter distributions, without having to change the nozzle bore hole.

A further possibility of variation is that of changing the material properties, for example by changing the temperature, as a result of which the material properties viscosity, surface tension and/or density can be adapted to an optimum drop production pattern.

An optimally set vibration-superimposed dropletization of the laminar jet breakup is exhibited in what is termed a static drop pattern FIG. 4 which can be visualized via an electronically controlled stroboscopic lamp. In this case the drop distribution corresponds to a monomodally distributed normal distribution with respect to mass.

The examples thus describe how drops 9, with varying narrow mass distribution, can be produced from a starting material that is capable of flow 2. The devices described for mass proportioning are used in a unit in which the drops 9 are added dropwise to a solidification liquid 11 to form solid particles 10.

After breakup of the jet to give the individual drop collective, the drop 9 first has a certain initial velocity at the breakup site. During free fall, the drop 9 accelerates for as long as the motive force (weight minus lifting force) is greater than the continuously increasing resistance force (flow force) This results in a falling velocity as a function of time and place until, at a given force equilibrium between the motive forces and the restraining forces, a steady state falling velocity u_{T,steady} state is achieved. Until uniform motion is achieved, the velocity of the drop 9 u_{T}(t)<u_{T,steady state}. The expression u_{T} (t=time, time interval) is taken to mean the time-dependent falling velocity of the drop 9.

The separate drops of the starting material that is capable of flow 9 are transferred into a solidification liquid 11 and must in this case overcome a phase boundary. Owing to the surface tension of the solidification liquid 11, there can be a high entry barrier and thus damage of the drop shape. It is then necessary to ensure that the forces resulting from the surface tension are minimized as far as possible and rather penetration of the drop of the starting material that is capable of flow 9 into the solidification liquid 11 is facilitated. This means that the surface tension of the solidification liquid σ_{solidification} liquid should be less than 50 mN/m, in particular less than 30 mN/m and as a result the transfer of the drops 9 can be effected more rapidly. In particular in the case of stabilizing solidification liquids which have an opposite polarity to the starting material that is capable of flow 2 (nonpolar in the case of polar starting material that is capable of flow 2, polar in: the case of nonpolar starting material that is capable of flow 2), a high interfacial surface tension is formed and the spherical drop form is stabilized. Drops 9 and thus solid particles 10 having a high sphericity are obtained at an interfacial surface tension between the material of the drops 9 and of the solidification liquid 11 between 25 and 50 mN/m, in particular between 30 and 50 mN/m and very particularly between 35 and 50 mN/m.

The surface tension of the solidification liquid 11 can be decreased, in particular in the case of polar solidification liquids 11, advantageously by adding surface-active or surface-decreasing substances (for example surfactants). Many possibilities are known to those skilled in the relevant art. By way of example, the chemical functional groups of alkyl/arylsulfates, sulfonates, -phosphates, -fluorates, -ethoxylates, ethers, oxazolidines, pyridinates or succinates can be introduced.

The extent of possible damage to the droplet shape 9 at the site of introduction, in addition to the surface tension of the solidification liquid 11, is also critically determined by the kinetic energy of the drops 9 which, to a certain proportion, is converted on impact into forming or deformation work, and the angle of incidence of the drops 9 onto the surface of the solidification liquid 11. Care must then be taken to ensure that the proportion of kinetic energy which is converted as deformation work on the drop 9 is minimized and optimized. For this, the vector relative velocity uᵣₑₗₐₜᵢᵥₑ between the drop 9 and the solidification liquid 11 must be reduced and optimized, advantageously by:
reducing the falling height or the falling time, in such a manner that the time-dependent falling velocity of the drop 9 u_{T}(t) is reduced—this means in practice introducing the drops 9 immediately or shortly after their complete separation to give the individual drop collective, in particular in the case of thermally unstable starting materials that are capable of flow 2.
changing the angle of incidence.
reducing the relative velocity uᵣₑₗₐₜᵢᵥₑ between the drop 9 and the solidification liquid 11.
or a combination of the listed measures above.

To achieve sphericity as high as possible, damage to the existent solid particle shape due to forming work liberated at the drop 9 on meeting the surface of the solidification liquid 11 must be prevented as far as possible. This can advantageously be achieved by introducing the drops 9 into the solidification liquid 11, in particular flowing solidification liquid 11, at an acute angle α, that is to say α≦90°, wherein the angle α is defined as the angle between the tangent to the movement tracks 50 of the drops 9 and the tangent to the surface of the solidification liquid 11, in each case plotted at the site of introduction into the solidification liquid 11, in particular into a flowing solidification liquid. This angle is shown in different views and embodiments in FIGS. 3, 6, 7, 8, 13, 15, 16 and 17.

Analogous angles can also result when the drops are instilled into a static solidification liquid and the mass proportioner 44 is moved (see FIGS. 18 and 19) or the movement track of the drops 9 is set by inclination of the mass proportioner 7 or a combination with a static and moved solidification liquid 11 (see. FIG. 8).

Further measures which may be employed advantageously to avoid damage to the drop of the starting material that is capable of flow 9 on transfer into the solidification liquid 11 may be found in reducing the vector, and thus direction-dependent or acting, relative velocity uᵣₑₗₐₜᵢᵥₑ between the drop 9 and the solidification liquid 11. As shown, for example in FIG. 8, by adapting the velocity of the solidification liquid 11 and the falling velocity of the drop 9 at the site of drop instillation, the relative velocity uᵣₑₗₐₜᵢᵥₑ can in principle be adjusted to 0 m/s. Thus in this boundary case, no forces due to movement act on the submerging drops 9.

Although this idealized case is advantageous for preventing damage to the drops 9, it is frequently advantageous, owing to the rapid cooling and with respect to the heat exchange which must proceed rapidly, to retain, in the solidification liquid 11, at least a certain relative velocity, particularly in the case of a melt, in particular in the case of a urea or urea-containing melt.

Maintenance of a frequently advantageous, but particularly advantageously minimized, relative velocity uᵣₑₗₐₜᵢᵥₑ between the drop 9 and the solidification liquid 11 at the site of introduction is also based in overcoming the phase boundary to be performed rapidly. If there is too low a density difference between the drops 9 of the starting material that is capable of flow and the solidification liquid 11, it is advantageous to utilize the still-existent excess velocity energy for overcoming the phase boundary, since otherwise the drops 9 have a tendency to float, in particular in the case of flowing solidification liquids, and very particularly solidification liquids which are conducted at an acute angle. In this case, advantageously a larger acute angle α is set. Precisely in the case of dropleting urea or urea-containing melts and/or suspensions of a ceramic material based on CeO₂/ZrO₂, an acute angle α>15°, in particular >45°, in particular >60°, and very particularly >70° must be set.

A further measure for avoiding damage to the drop form 9 on entering the solidification liquid 11 can be taken by an upstream hardening section during the falling time of the drops 9 of the starting material that is capable of flow 2. In this case, sufficient hardening of the sheath of the drop 9 is effected. By increasing the strength of the shell of the two-phase drop (sheath: solid; core: capable of flow), the damaging deformation at the site of introduction into the solidification liquid can advantageously be suppressed (see FIG. 9).

Corresponding to the above-described measures which have the purpose of semi non-destructive transfer of the drops 9 into the solidification liquid 11 with as little damage as possible, advantageously both the hardening and also the reshaping and/or stabilizing step in the solidification liquid 11 can be effected for example by a cooling (hardening) and/or reshaping and/or stabilizing liquid in the production of spherical solid particles. In this case the physical principle of pairing of opposite polarities is utilized, that is to say for example the polar urea melt drop 9 is contacted with a nonpolar solvent as solidification liquid 11. In this case the smallest outer surface of a geometric body forms, that is a sphere. It is particularly advantageous to ensure that after immersion of the drop 9 that is still capable of flow it still has sufficient mobility or flowability for shaping to compensate for damage. This shaping to form a spherical solid particle 10 is illustrated in FIG. 10. The drop 9 is still in a relatively nonrounded shape, but the solid particle 10 has a markedly more spherical shape.

In addition to the improvement in sphericity (reshaping), in the solidification liquid 11, in particular the hardening or solidification to give the spherical solid particles 10 having narrow particle size, density and mass distributions proceeds. The advantageous measures set forth hereinafter may be effected, in particular using flowing solidification liquids 11. A coalescence which is unwanted in this phase (particles 10 still not hardened) (this is taken to mean the coagulation of still unhardened particles 10) or aggregation (this is taken to mean the combination of individual particles to form particle aggregates), can advantageously be prevented by a continuously conducted solidification liquid 11 which guarantees that the solidifying drops 10 are sufficiently rapidly transported away and subsequently guarantees a sufficient spacing of the individual drops or the later individual particles 10 from one another.

It is largely understandable that in the event of still-sufficient flowability of the submerged and spherical particle 10 in the solidification liquid 11, flow forces cause damage to the surface and/or shape. It is particularly advantageous to minimize the relative velocity between the sinking and/or reshaping spherical particle 10 and the solidification liquid 11, that is to say the particle 10, in the boundary case, falls with a vertical movement track 50 in the solidification liquid 11 at a constant velocity according to Stokes's law in a static medium owing to the difference in density. This is taken to mean the velocity of the particle 10, around which flow passes, through the solidification liquid 11.

It is frequently advantageous, because this ensures rapid mass transfer and heat exchange, to optimize correspondingly high relative velocity vector uᵣₑₗₐₜᵢᵥₑ between the particle 10 and the solidification liquid 11. In combination with the accelerating and retarding effect of the solidifying drop or of the particle 10 at the site of instillation or after its complete submersion, the optimized flow conditions can be described by the dimensionless Reynolds number [Re] and Froude number [Fr].

It is particularly advantageous when the flowing solidification liquid 11 is conducted in a laminar manner relative to the velocity of motion of the drop/particle at the site of instillation, that is to say it has a Reynolds number [Re] of less than 2.320, and very particularly advantageously laminar flow conditions of the particle 10, around which flow passes, in the Re range of 0.5 to 500 and Froude Fr of 0.1 to 10, particularly less than 5 and very particularly less than 2 are set in an optimized manner. The values for describing the flow conditions are based on the submerged particles, around which flow passes, shortly after the site of instillation.

The optimized setting of laminar flow conditions of the solidification liquid, in particular shortly before the point of instillation, can be effected by longitudinal or rotating flows, in particular by pronounced and/or particularly advantageously, fully developed flows of longitudinal and rotating flow types. Pronounced and fully developed flows are taken to mean defined flows (for example whirlpool, twist) and/or in particular specially conducted flows (wall boundaries, channel flow etc.). These flows particularly have the advantages that vortex formation and/or wall contact can be reduced. The advantageous embodiments are described in connection with the figures and are subject matter of the subclaims:

It is further advantageous when, because of the occurrence of force pairs between the drop 9 and the solidification liquid 11 conducted at a defined angle, an angular momentum is induced (FIGS. 11, 12) which leads to a desired rotary movement or rotation of the drop 9: this induced rotary movement stabilizes the drop 9 substantially or subsequently also supports the reshaping to give a spherical solid particle 10. This effect can advantageously be controlled by the angle of inclination and the relative velocities and/or by imposing velocity fields in two axes, for example by an additional transverse component—for example by additional tangential flow in a funnel having an overflow edge in addition to the main flow direction (horizontal flow or vertical flow in a funnel having an overflow edge) be advantageously utilized for liquid movement.

If the hardening is performed by cooling, particularly in the case of melts and in particular in the case of urea or urea-containing melts, a solidification liquid 11, and in particular a flowing solidification liquid, offers significant advantages compared with cooling in the gas phase, owing to the higher heat capacity, density and thermal conductivity of the solidification liquid 11. In this case, not only heat exchange, but also in particular in the case of chemically hardening systems mass transfer, is significantly increased by the flow conditions established compared with gas phases and/or static solidification liquids. Advantageously, there is a substantial increase not only in heat transfer but also mass transfer coefficients. In addition, advantageously steady-state starting conditions are guaranteed, for example temperature, concentration at the point of instillation of the drop 9 into the flowing solidification liquid 11, and to this extent are advantageously optimized parameters.

In the case of urea or urea-containing melts, for hardening, the solidification liquid 11 is used as coolant. By varying the temperature of the solidification liquid, optimized hardening and reshaping times to give the spherical particle can be set. In the case of urea or urea-containing melts, the use of a nonpolar coolant or a solidification liquid which has a freezing point below that of water, is particularly advantageous, and is very particularly advantageous by setting a temperature of the solidification liquid 11 directly upstream of the point of instillation of the drops 9 of −20° C. to +20° C.

In the case of suspensions based on a ceramic material and a binder, by varying the temperature of the solidification liquid, the shaping times and/or chemical hardening times can be controlled in a deliberate manner.

### Conditioning the Solid Particles

Use of a slightly wetting or non-wetting solidification liquid 11 can also advantageously be used in the storage of the spherical solid particles 10. It is preferred if, in particular, urea particles 10 are conditioned by aminotriazines and/or oxytriazines and/or hydrocarbons.

Conditioning leads to improved flowability of the solid particles and prevents caking.

The conditioning agents can also be applied subsequently to the finished solid particles 10 by spraying and/or pelletizing. It is particularly preferred when a fluid (solidification liquid 11) used in production of the solid particle 10 simultaneously acts as conditioning agent. In this manner bead generation and conditioning can proceed in one method step.

The method for achieving solid particles having high sphericity, in particular spherical particle shape and narrow particle size, mass and density distributions has, in summary, in particular the following aspects:
1. Setting and keeping constant a mass flow of a starting material that is capable of flow 2 for achieving a narrowly distributed monomodal mass distribution of the drops 9 or solid particles 10 to be produced.
2. Mass proportioning 7, 8 or drop generation 9 in accordance with the laws of laminar jet breakup without or with resonance excitation, in particular in the flow regimes of dripping and dropletizing (laminar jet breakup) which can be described via dimensionless numbers.
3. Ensuring a low-destructive, in particular nondestructive, transfer of the drops 9 generated into a liquid phase of a solidification liquid 11 (overcoming a phase boundary).
4. Ensuring a low-destructive, in particular nondestructive, and rapid removal of the particles by the solidification liquid 11 to prevent coalescence and/or aggregation of the drops of the starting material that is capable of flow under preconditions of preventing damage by the flow forces prevailing in each case.
5. Reshaping and/or stabilizing the drops of the starting material that is capable of flow to form spherical solid particles 10 by the solidification liquid 11 taking into consideration a more or less rapid hardening to give the spherical solid particles 10.
6. Ensuring sufficient hardening within the solidification liquid 11 for the purpose of manipulating the spherical solid particles 10.
7. Conditioning the spherical solid particles.

Instillation for the above-described method is explained hereinafter with reference to the examples of FIGS. 3, 6 and 13. The mass proportioner 7, 8 divides the jet into drops 9 of narrow mass distribution, in accordance with the above description of FIG. 5.

The damage-free and nondestructive transfer of the drops 9 into the solidification liquid 11 for example by the measures of surface tension (σ_{solidification liquid}<σ_{drop}), setting an angle α and also reshaping/stabilizing (interfacial surface tension, polarity difference), hardening (coolant) and/or removal (flowing) of the spherical solid particles 10 is shown in detail in FIG. 6 and in a particular embodiment in FIG. 13.

After transfer of the drops 9 into the solidification liquid 11, the drops 9 reshape and harden to form spherical solid particles 10. The drops 9 here essentially follow a vertical movement track 50.

In FIG. 3 it is further shown that the spherical solid particles 10 which are shaped-stabilized and hardened in the instillation apparatus or in the duct channel pass into a storage vessel 13 for the solidification liquid 11. By means of a mechanical separation unit 12, for example a sieve basket, the hardened and spherical solid particles 10 are separated from the solidification liquid 11.

In the case of urea, the solidification liquid 11 is cooled, wherein this is conducted via a heat exchanger 15 by means of a centrifugal pump 14 to the instillation apparatus. In this case, advantageously the heat of solidification (for example heat of crystallization) which is removed in the heat exchanger 15 can be increased by means of a heat pump to the melt temperature of urea and consequently energy recovery and heat coupling can be achieved. This is particularly advantageous in the dropletization of melt phases.

Further advantageous embodiments are described in connection with the figures and are subject matter of the subclaims.

A pronounced, in particular, fully developed, flow of the solidification liquid 11 is preferably defined by a fully developed channel flow, in particular in the form of a duct channel. A fully developed flow, in particular in a duct channel of the instillation apparatus, is shown in FIG. 6. Generating the advantageously usable angle α is effected by an overflow weir 31 which is specially shaped in terms of fluid mechanics, which overflow weir produces a very smooth diversion of the solidification liquid 11 (coolant), wherein the contour of the overflow weir 31 is adopted or reproduced by the coolant at its surface and subsequently the acute angle α between the tangent to the movement track 50 of the drops 9 and the tangent to the surface of the flowing solidification liquid, in each case plotted at the site of introduction into the flowing solidification liquid 11, is produced.

In special embodiments of the duct channel or of the fully developed channel flow, instead of the specially shaped overflow weir 31, use is made of a flow impeder 31 (see FIG. 15) specially shaped in terms of fluid mechanics, or particularly advantageously, use is made of an adjustable flow impeder 31 in the form of a flight (see FIG. 16). Both embodiments again cause the development or reproduction of an acute angle α between the tangent to the movement tracks 50 of the drops 9 and the tangent to the surface of the flowing solidification liquid, in each case plotted at the site of introduction into the flowing solidification liquid.

The flight flow impeder (FIG. 16) has the advantages, firstly of rapid adaptation or change of the angle which is formed and secondly in the setting of an underflow, so that particularly advantageously, rapid removal of the spherical particles 10 from the instillation region can be effected.

Instillation into a funnel having an overflowing solidification liquid also has a similar effect (FIGS. 13, 14). Guide vanes can be introduced into the funnel, so that again a fully developed channel flow can advantageously be effected. In a preferred embodiment of the device according to the invention for producing spherical urea particles 10, the solidification liquid 11, in particular the coolant liquid, is fed via a plurality of symmetrically arranged pipes 30. The solidification liquid 11 is fed either vertically and against the direction of gravity via a downwardly bent tube or/and can be set into a spin motion by tangentially arranged feed lines. The first tube arrangement guarantees the vertical transport of the solidification liquid, so that a very calm and smooth surface can be set. The second tube arrangement causes the spin motion under calm flow conditions. The flows are fully developed. A further calming of the flow is effected by expanding the circular funnel structure from the bottom in the direction of the liquid surface, corresponding to a type of diffuser.

With the aid of a specially shaped overflow weir 31, the solidification liquid 11 transfers in an unimpeded manner into a funnel region. The specially shaped overflow weir 31, at the outside of the funnel, transfers tangentially from its inclination to a smooth circle-segment-like rounding, this is followed by a type of parabolically shaped rounding, the legs of which proceed very flatly in the direction of the inner funnel (see FIG. 13). As a result, the liquid can be kept over a relatively long period at approximately the same level. The transfer from the parabolic segment to the internal funnel wall again proceeds tangentially via a type of more intensely curved circle segment. All curved segments themselves form a unit and because of the tangential transfers to the funnel walls, likewise form a unit appearing closed to the exterior. A further advantage of this shaping is that it provides a sufficiently high film thickness of the solidification liquid 11 in the guide duct channel. As a result, advantageously, premature contact of the still insufficiently hardened urea particle 10 with the wall can be avoided. In the specific application case, liquid heights of 20-40 mm are advantageously set, measured as the distance between the tangent of the horizontally orientated overflow edge to the liquid surface.

Shaping and also removal of the spherical solid particles 10 advantageously proceeds via the respectively prevailing flow velocity of the coolant liquid (solidification liquid 11). In a specific application case, at the horizontal overflow edge this is about 0.2 to 0.8 m/s, wherein this value changes only insignificantly as a function of falling height as a result of the special shape of the overflow weir. The sinking velocity of the spherical urea particle 10 is, at a diameter of about 2.5 mm, about 0.4 m/s. For optimum shaping and established cooling, the spherical urea particle 10, even after a few tenths of a second, is already formed and sufficiently hardened. This means a shaping and cooling process completed already after a few lengths in the upper part of the funnel, in particular after the stroboscopically visualized bead image length of about 5 to 12 solid particles 10.

The geometric shaping of the special overflow weir 11 proceeds according to fluid mechanics. In the specific application case, for example for producing spherical urea particles 10, laminar flow conditions exhibit Re numbers relative to the solid particle 10 of less than 2320, in particular between 0.5 and 50.0, and also Froude numbers of less than 10, particularly less than 5, and very particularly less than 2.

In a special embodiment of the duct channel funnel (FIGS. 13, 14), guide vanes, in particular tapered guide vanes, are introduced into the funnel for mechanical guidance of the flow or for development of a fully developed channel flow. The guide vanes are tapered downward, so that a sufficient liquid height remains along the inclined funnel wall, and subsequently wall contact of the spherical solid particles 10 can be prevented. The guide vanes can also be shaped so as to be curved, so that the advantage of the spin motion or the two-dimensional flow fields can be utilized.

Owing to the circular symmetry of the funnel (see FIG. 14) with or without guide vanes, advantageously, a circularly symmetrical dropletizing unit having a plurality of nozzles can be arranged.

Owing to the rapidly succeeding processes, a modular construction can advantageously be achieved for increasing capacity, by arranging a plurality of funnels and dropletizing units in a falling tube. The spherical urea beads 10 are separated from the shaping coolant liquid by mechanical means.

In a further embodiment (FIG. 6), instead of the funnel, use is made of a duct. The coolant medium is fed in a similar manner to the description set forth hereinbefore via a box which has the vertically orientated pipe feeds, in such a manner that again a smooth feed flow which is optimum in terms of fluid mechanics results. The flow is directed along walls and deflected in the direction of a specially shaped flow impeder which corresponds to that of the overflow weir of FIG. 13. The flow again is fully developed. In this case the residence time necessary for shaping and hardening over the length of the channel flow is defined in connection with the flow velocity. In this case, by means of the width of the duct, correspondingly higher liquid heights can also advantageously be set.

In a further embodiment (FIG. 17), the measures for generating a spherical solid particle 10 by forming a pronounced rotary flow, in particular by forming a whirlpool shape 61 in a stirred tank 60, are effected. Using a stirrer element 63 arranged at the bottom, the rotary speed 64 of which for setting a defined velocity, and also the spacing from the liquid surface, can be varied, a smooth whirlpool shape is formed, and consequently an angle α between the tangent to the movement tracks 50 of the drops 9 and the tangent to the surface of the flowing solidification liquid 11, in each case plotted at the site of introduction into the flowing solidification liquid, is generated. Owing to the spin motion and under the influences of centrifugal and coriolis forces, the urea particles 10 exhibit a helical movement track, as a result of which the residence time is correspondingly advantageously prolonged.

In a further preferred embodiment, a rotating vessel or a rotating solidification liquid 11 is used for producing solid particles 10 (FIG. 20). In this case, in the outer region, a circular duct channel bounded by the walls of two cylinders (ring) is formed, in such a manner that a fully developed rotary flow is generated. In this special embodiment, the solidification liquid 11 is fed via a sliding ring seal at the bottom of the vessel 201. The solidification liquid 11 is transported via a riser pipe 202 into a ring-shaped distribution device 203/204 having inlet orifices, in particular holes 205, in the actual instillation region 206. The inlet orifices 205 of the distributor device are arranged just below the solidification liquid surface, somewhat below the actual site of instillation. As a result of this distance, any interfering longitudinal motion of the solidification liquid 11 onto the solid particles 10 is prevented. For a movement track 50 of the drop 9 perpendicular to the surface of the solidification liquid, α=90°. The separate drops 9 of the mass proportioner, on phase transfer, experience as a result of the torque of the inflow, an advantageous spin motion and are put into a helical motion by the rotation of the vessel 211 and the solidification liquid 11, as a result of which the residence time is correspondingly prolonged. As a result of the special construction of the instillation region, a calmed surface of the solidification liquid forms. At relatively high peripheral velocities, alternatively, certain angles of inclination of the solidification liquid 11 surface which is lifted outward or inclined by the centrifugal force can also be achieved, this means an angle of α<90°. Not only the spherical solid particles. 10 but also the solidification liquid 11 are forced by the flow into the bottom region of the rotating vessel. In the bottom region, either owing to a conical and expanding collection region 209, the solid particles 10 are separated by gravitation, or owing to a sieve fabric installed there are separated from the slightly heated solidification liquid 11. The solidification liquid 11 freed from the urea particles 10 rises against the force of gravity into the outlet or recycle region 207 which is formed at the site of instillation by an internal funnel arranged geodetically somewhat lower compared with the actual level of the solidification liquid 11. Discharge of the spherical urea particles 10 is achieved by discontinuous opening of the shutoff element 210, wherein the spherical urea particles 10, together with a small part of the solidification liquid 11, are accelerated from the vessel into an external collection and separation apparatus, owing to centrifugal forces. All other plant components, such as, for example, mass proportioner, heat exchanger, are the same as in the previous descriptions.

In a further particularly preferred embodiment (FIG. 21) of the fully developed and laminar rotary flow, the solidification liquid 11 is fed tangentially 302, 303 into the ring-shaped region (two cylinders) of an upright vessel. A further difference from the previously mentioned rotating vessel is the closed mode of construction of the apparatus, the internal cylinder (no funnel for drainage of the fluid phase) is closed at the top. The effects are similar to those of the rotating vessel with the development of a helical motion 305 of the solid particles 10 and the advantageous prolongation of the residence time, and also the possible setting of an inclined surface of the solidification liquid 11 with correspondingly high peripheral velocities. The solid particles are separated off from the solidification liquid in a customary manner using a known separation device such as, for example, a cyclone 307 or via a wire mesh or sieve 12. The advantage of the apparatus is the spherical solid particle 10 discharge, which can be made semicontinuous, via the shutoff valve 308, wherein by means of the closed system, the level 102 of the solidification liquid 11 can be maintained and replenishment effected by a level meter 16. All other plant components such as, for example, mass proportioner, heat exchanger, are the same as in the previous descriptions.

FIG. 27 shows the dropletizing of a starting material that is capable of flow, in particular a suspension based on a ceramic material and a binder, into a static solidification liquid 11. This has two mutually sparingly miscible or immiscible phases or substances of different polarities and/or different densities. The separate drops 9 of the mass proportioner are introduced in this case into a nonpolar and light phase of the solidification liquid 11 which has a low surface tension, in particular less than 30 mN/m. In this first phase of the solidification liquid, predominantly the reshaping of the drops 9 that are still capable of flow proceeds to give spherical drops 9 that are still capable of flow. The solidification or hardening proceeds in the second, denser phase of the solidification liquid 11 to give the spherical solid particles 10. In this case a low interfacial surface tension between the lighter and denser phase of the solidification liquid must be, in particular, taken into account. This should advantageously have a value less than 10 mN/m. The hardened spherical solid particles 10 are separated off in a conventional manner via a separating unit, for example via a sieve or filter 12 from the heavier phase of the solidification liquid and the separated solidification liquid again is fed to the apparatus. All other plant components, such as, for example, mass proportioner, heat exchanger, are the same as in the previous descriptions.

FIG. 9 shows a particularly advantageous embodiment of sheath hardening for the example of producing spherical urea particles in which a cooling liquid 21 is atomized by two-component nozzles 20. In this case, a plurality of two-component nozzles 20 are arranged circularly symmetrically on the lid of the upstream hardening section and at a defined angle α_{two-component nozzle} to the falling axis of the urea drops 9. Using the two-component nozzles 20, a cooling medium 21, in particular nonpolar hydrocarbon compounds, is injected to give a type of sprayed mist, or an aerosol. This aerosol, owing to its nonpolar character, has significant advantages over the polar urea, since in the interaction of the “incompatible” compounds, or semi-mutually insoluble, compounds, the smallest surface area of a body is formed. This is a sphere. As a result, shaping is substantially supported. The formation of very fine droplets of the fluid to form an aerosol significantly supports the removal of heat, since by creating a very large heat exchange area (surface of the fluid droplets) the wetting can also advantageously be utilized. As a result, the necessary cooling sections can be kept very small.

Alternatively, or else in combination therewith, a pure dripping method can be used in which the drops 9 are not generated by dividing a laminar flow.

FIG. 18 diagrammatically shows a simple device which has a perforated plate 40. This perforated plate 40 is arranged beneath a reservoir 41 for the starting material that is capable of flow, for example urea melt. In the perforated plate 40 is arranged a multiplicity of individual nozzles 42 which, in the simplest case, are boreholes in the perforated plate 40. Alternatively, the nozzles can also have a funnel-like contour tapering from top to bottom, so that the starting material that is capable of flow is readily conducted through the nozzles 42. When a pressure difference is applied across the nozzle plate 40, individual drops drip from the nozzles 42, wherein the perforated plate 40 acts together with the nozzles 42 as mass proportioner.

Since the flow process in this case is not excited externally, for example by vibrations, the drops 9 form solely under gravity. This generally lasts longer than a high-frequency excitation of the dropletizing units. At all events, the embodiment has the advantage that a large amount of nozzles 42 can be arranged on one perforated plate 40.

The drops 9 can be solidified to solid particles 10 in a manner as has been described in the other embodiments.

In a further embodiment according to FIG. 19, the flow velocity for dripping is generated by a centrifugal force. FIG. 19 shows a perspective view of a round perforated plate 40 at the periphery of which a wall 43 is arranged. The wall 43 together with the perforated plate 40 forms the reservoir 41. The nozzles 42 for passage of the starting material that is capable of flow are arranged at the periphery of the perforated plate 40. The starting material that is capable of flow is brought into the reservoir by a feed line 44, wherein the feed line 44 is rotated during transport. As a result, the exiting starting material that is capable of flow experiences an acceleration outward in the direction of the wall 43; the starting material is forced against the wall 43. By setting the transport velocity, the rotation and the filling height, a defined pressure can be set at the nozzles. The nozzles 42 then remove the starting material that is capable of flow from the nozzle plate 40.

In principle this embodiment can also be formed in such a manner that the feed line 43 is static and the perforated plate 40 rotates. In this case, the nozzles 42 are arranged in the wall 43.

### Embodiments of Urea Particles:

The object is also achieved by urea particles of high constancy of mass as claimed in claims 48, 49 and 52.

Urea particles according to the first solution have the following features:

(a) a sphericity of >0.923,
(b) an apparent particle density in the range between 1.20 and 1.335 g/cm³ and
(c) a diameter between 20 μm and 6000 μm, at a relative standard deviation of <10%.

Urea particles according to the second solution have the following features:

a) an apparent particle density of the urea particles in the range between 1.25 and 1.33 g/cm³ and
b) a mean minimum Feret diameter of the urea particles in the range between less than or equal to 4 mm, in particular between 1.2 and 3.5 mm, in particular between 1.4 and 3.2 mm, with a relative standard deviation in each case of less than or equal to 5%
c) and a ratio of minimum Feret diameter to maximum Feret diameter of the urea particles of greater than or equal to 0.92 for a diameter of the urea particles of 2400 to 2600 μm, of greater than or equal to 0.90 for a diameter of the urea particles of 1800 to 2000 μm, of greater than or equal to 0.87 for a diameter of the urea particles of 1400 to 1600 μm, of greater than or equal to 0.84 for a diameter of the urea particles of 1100 to 1300 μm.

Urea particles according to the third solution are obtainable by a method as claimed in one of claims 1 to 47.

Hereinafter, advantageous embodiments are described which may be applied in principle to all of the three solutions.

A preferred embodiment of the urea particles according to the invention have a sphericity of >0.923, particularly ≧0.940, in particular ≧0.950, in particular ≧0.960, in particular ≧0.970, and very particularly ≧0.980.

In particular, using the above-described embodiments of the method, urea particles may also be produced which are characterized by a diameter between 1000 μm and 4000 μm, preferably between 1000 and 3200 μm, preferably between 1100 and 3000 μm, preferably between 1500 and 3000 μm, and very preferably between 1100 and 1300 μm, or 1400 and 1600 μm, or 1800 and 2000 μm, or 2400 and 2600 μm, at a relative standard deviation of ≦10%, preferably ≦5%, preferably ≦4%, in particular ≦3.5%.

Further advantageous embodiments of the solid particles are described in connection with the figures and are subject matter of subclaims.

The invention contains the finding that when the abovementioned method steps are complied with, the most varied solid particles 10 having high sphericity and narrow size distribution can be produced. When, for example, the starting material used is a urea melt, unique urea particles 10 may be produced.

These urea particles 10 according to the invention are suitable, in particular, in a catalyst of a motor vehicle for reducing nitrogen oxides.

The sphericity is calculated from the minimum and maximum Feret diameter which are defined in DIN standard 66141 and are determined as specified in ISO standard CD 13322-2.

Sphericity is a measure of the exactness of the rolling movement of a solid particle 10, in particular during transport in a metering apparatus. A high sphericity, ideally a sphere (sphericity=1), leads to a reduction in rolling resistance and prevents a tumbling motion due to non-spherical surface sections such as, for example, flat points, dents or elevations. The meterability is facilitated thereby.

The apparent particle density, in particular the mean apparent particle density, is taken to mean according to E standard 993-17 DIN-EN from 1998, the ratio of the mass of an amount of the particles (that is of the material) to the total volume of the particles including the volume of closed pores in the particles.

According to the standard, the apparent particle density is measured by the method of mercury displacement under vacuum conditions. In this process, when a certain pressure is applied, circular and crevice-shaped, in particular open, pores of defined diameter are filled with mercury and the volume of the material is thus determined. Via the mass of the material (that is to say the particles), in this manner the apparent particle density, in particular the mean apparent particle density, is calculated.

Advantageous ranges for the mean apparent particle density of urea particles are values between 1.250 and 1.335 g/cm³, in particular between 1.290 and 1.335 g/cm³. It is also advantageous when the mean apparent particle density is between 1.28 and 1.33 g/cm³, very particularly between 1.29 and 1.30 g/cm³.

The minimum Feret diameter and the maximum Feret diameter are defined in DIN standard 66141 and are determined as specified in ISO standard CD 13322-2, which concerns particle size determination of substances by dynamic image analysis. In this method digital snapshots are taken of the particles which are being metered, for example, via a transport chute and fall down. The digital snapshots reproduce the projected surfaces of the individual particles in the various positions of motion. From the digital snapshots, measured data of particle diameter and particle shape are calculated for each individually recorded particle and statistical analyses are carried out on the total number of particles recorded per sample.

Advantageous embodiments for the urea particle 10 have the following mean minimum Feret diameter: less than or equal to 4 mm, in particular between 2 and 3 mm, with a relative standard deviation of less than or equal to 5%. In addition it is advantageous when the mean minimum Feret diameter of the urea particle 10 is in the range between 2.2 and 2.8 mm with a relative standard deviation of less than or equal to 4%. It is very advantageous when the mean minimum Feret diameter is in the range between 2.4 and 2.6 mm with a relative standard deviation of less than or equal to 3.5%.

For determination of particle diameter and particle shape, the Feret diameters are used. The Feret diameter is the distance between two-tangents to the particle which are plotted perpendicularly to the direction of measurement. The minimum Feret diameter is therefore the shortest diameter of a particle, and the maximum Feret diameter is the longest diameter of a particle.

Urea particles 10 according to the invention have a sufficiently great constancy of mass, that is the urea particles 10 are sufficiently identical to one another so that the constancy of particle metering is comparable with the constancy of metering of a fluid.

An investigation of the constancy of mass of embodiments of the urea particles according to the invention was carried out. The constancy of mass is defined as the relative standard deviation in % of the mass of 1000, 200, 100 or 10 particles (confidence level 1−α=0.95). The determination is performed by weighing 1000, 200, 100 and 10 counted particles.

The constancy of mass of the particles studied (dropletizing method) is as follows:

Number of particles

| Diameter | 1000 | 200 | 100 | 10 |
|---|---|---|---|---|
| 2.5 ± 0.1 mm | ≦10% | ≦10.5% | ≦11% | ≦18% |
| 1.9 ± 0.1 mm | ≦10% | ≦10.5% | ≦11% | ≦18% |

An advantageous embodiment of the urea particle 10 according to the invention has a pore volume distribution and pore radius distribution corresponding to the semi-logarithmic plot according to FIG. 22. The measurements were carried out using the following parameters:

Instrument type: Pascal 440
Sample name: Charge 0001
According to DIN 66 133 and DIN EN 993-17; 2.4-2.6 mm diameter

The pore distribution shows how many pores of a certain pore size the urea particles 10 have.

The stated pore distribution of the urea particles 10 shows that relatively many pores of small diameter and few pores of large diameter are present. This leads to high strength of the urea particles 10.

Table 1 shows the numerical representation of the above semilogarithmic diagram. The percentage pore volume fractions are given as a function of the pore size of the urea particles 10. From the table it can be seen, for example, that 58.15% of the total pore volume is made up of a pores having a pore radius of less than or equal to 50 nm.

In a further batch of the particles according to the invention, the total pore diameter range which occurs is subdivided into 3 representative subranges and shown in Table 2: of in total 100% of the total pore volume present, 25.89% is made up of pores having a diameter between 2000 and 60 000 nm, a further 15.79% is made up of pores having a diameter between 60 and 2000 nm, and finally more than half, that is to say 58.32%, of the volume is made up of pores having a diameter between 2 and 60 nm.

In a preferred embodiment, the urea particles 10 have a mean pore volume of less than 120 mm³/g, particularly less than 60 mm³/g, very particularly 30 to 60 mm³/g, in particular less than 30 mm³/g, measured as specified in DIN 66133. The pore volume gives the volume of the mercury pressed into the pores based on 1 g of sample mass.

The porosity is given by the ratio between pore volume and external volume of the sample. It therefore indicates how much space of the total volume is occupied by pores (%).

The pore distribution is measured as specified in DIN 66 133 via measurement of the volume of mercury pressed into a porous solid as a function of the pressure applied. The pore radius can then be calculated therefrom by what is termed the Washburn equation.

The volume pressed in as ordinate as a function of pore radius as abscissa gives the graphical plot of the pore distribution.

Advantageous urea particles 10 are those which have a mean pore radius of less than 25 nm, particularly preferably less than 17 nm.

Beads having a small pore radius have a particularly high strength. This is advantageous for good abrasion behavior during metering and storage.

In addition it is advantageous when a urea particle has a median porosity of less than or equal to 7, in particular less than or equal to 6%, measured as specified in DIN 66 133.

The sphericity of the particles was measured using a Camsizer 187 instrument (Retsch Technology, software version 3.30y8, setting parameters: use of a CCD zoom camera, surface light source, 15 mm chute, guide vane, 1% particle density, image rate 1:1, measurement in 64 directions) in accordance with ISO standard CD 13322-2 and analyzed as specified in DIN 66 141. The measurement is based on the principle of dynamic image analysis, and the sphericity SPHT is defined as

$$SPHT = \frac{4 π A}{{U}^{2}}$$

where A=projected area of the particle and U=circumference of the particle.

For the projected image area of a circle, that is to say a spherical particle, SPHT=1, for deviating particle shapes SPHT<1. The sphericity is a measure which characterizes the rollability of the particles in transport. Good rollability of the urea particles 10 leads to a reduction of the transport resistance and minimizes the tendency of the urea particles 10 to stick together. This facilitates the meterability.

It is preferred when the urea particle 10 is present conditioned by amino triazines and/or oxytriazines and/or hydrocarbons. The conditioning leads to an improved flowability of the particles and prevents caking of the urea particles 10 during storage. It is particularly advantageous to make use of aliphatic hydrocarbons or melamine and melamine-related substances as conditioning agents.

The conditioning agents can be applied subsequently by spraying onto the finished urea particles 10.

It is particularly preferred when a coolant used in the production of the particle simultaneously acts as conditioning agent. In this manner a subsequent process step for conditioning is no longer necessary.

It is further advantageous when the urea beads have a mean specific surface area of greater than 5 m²/g, in particular greater than 9 m²/g. This is the specific surface area of the pores in the interior of the particle, measured as specified in DIN 66 133.

An important advantage of the urea particles 10 is their high fracture strength and hardness (ultimate elongation behavior) which can be due to the structure or microstructure of the embodiments.

Advantageously, an embodiment of the urea particles has a fracture strength distribution in which 10% have a fracture strength greater than 1.1, MPa, 50% have a fracture strength of 1.5 MPa and 90% have a fracture strength of 2.1 MPa.

It is particularly advantageous when the fracture strength distribution is such that 10% have a fracture strength greater than 1.4 MPa, 50% a fracture strength of 2.2 MPa and 90% a fracture strength of 2.8 MPa.

It is also advantageous when the embodiments of the urea particles 10 have a relative ultimate elongation of less than or equal to 2%, in particular less than or equal to 1%.

The fracture strength of the embodiments of the particles was measured using a GFP granule strength test system from M-TECH.

FIG. 25 shows, for two embodiments of the urea particles 10, the sum curve of the fracture strength distribution.

FIG. 26 shows the change in length during loading of the urea particles 10 with a breaking force.

The advantageous microstructures of the urea particles 10 can be seen, for example, from FIGS. 23A, 23B, 24A, 24B. FIG. 23A shows an embodiment of the urea particle 10 according to the invention having a mean diameter of approximately 1.9 mm. The surface of the urea particle 10 shows a finely crystalline outer sheath. The high sphericity can be seen. FIG. 23B shows a sectional view in which the homogeneous microstructure can be recognized, in particular the amorphous structure in the largest part of the image.

FIG. 24A, shows as further embodiment, an industrially prilled urea particle having a mean diameter of approximately 1.9 mm. FIG. 24B shows a crystalline microstructure of the particle according to FIG. 24A. In FIG. 24B, small crystallites can be recognized.

It is advantageous when an embodiment of the urea particle 10 according to the invention has a finely crystalline outer sheath. It is particularly advantageous when a maximum crystallite size of less than or equal to 20 μm is present, particularly less than or equal to 1 μm, in particular less than or equal to 0.1 μm, very particularly when an amorphous structure is present.

Preference is given to urea particles 10 whose biuret content is less than or equal to 20% by weight, particularly less than or equal to 12% by weight, in particular less than or equal to 7% by weight, in particular less than or equal to 5% by weight, very particularly less than 2% by weight.

It is in addition advantageous when the water content is less than or equal to 0.3% by weight. If the water contents are too high, there is the risk of caking of the particles.

It is further desirable when the aldehyde content is less than or equal to 10 mg/kg and/or the free NH₃ content is less than or equal to 0.2% by weight, in particular less than or equal to 0.1% by weight.

It is advantageous when the sum proportion of alkaline earth metals is less than or equal to 1.0 mg/kg, in particular less than or equal to 0.7 mg/kg.

It is advantageous when the sum proportion of alkali metals is less than or equal to 0.75 mg/kg, in particular less than or equal to 0.5 mg/kg.

It is advantageous when the proportion of phosphate is less than or equal to 0.5 mg/kg, in particular less than or equal to 0.2 mg/kg.

It is advantageous when the proportion of sulfur is less than or equal to 2.0 mg/kg, in particular less than or equal to 1.5 mg/kg, very particularly less than or equal to 1.0 mg/kg.

It is advantageous when the proportion of inorganic chlorine present is less than or equal to 2.0 mg/kg, in particular less than or equal to 1.5 mg/kg, very particularly less than or equal to 1.0 mg/kg.

The impurities are of importance, in particular, for use in combination with catalytic exhaust gas purification.

### Embodiments of Ceramic Particles:

Further preferred solid particles which are obtainable by the process according to the invention are particles made of a ceramic material.

The solid particles according to the invention made of a ceramic material are characterized by

(a) a sphericity of >0.930,
(b) a diameter between 20 μm and 6000 μm at a relative standard deviation of <10%.

A preferred embodiment of the solid particles made of a ceramic material is characterized by a sphericity of ≧0.960, in particular ≧0.990. Further preferred embodiments of the solid particles made of a ceramic material are characterized by a diameter between 100 μm and 2500 μm at a relative standard deviation of ≦5%, preferably ≦46, in particular ≦1%, and in addition, by a diameter between 300 μm and 2000 μm, at a relative standard deviation of ≦3.5%.

As milling bodies in mills, in particular high-performance mills, use may be made, for example, of ceramic solid particles which are characterized in that the ceramic material is a cerium-stabilized zirconium oxide having a CeO₂ content of 10 to 30% by mass. In addition, these solid particles are characterized by an apparent particle density (after sintering) in the range between 6.100 and 6.250 g/cm³.

Further advantageous embodiments of the solid particles are described in connection with the figures and are subject matter of subclaims.

The object is also achieved by a device as claimed in claim 97. The mode of functioning and the components of this device have already been set forth in connection with the method description.

### EXAMPLES

The invention will be described in more detail by the examples hereinafter, wherein Examples 1 to 4 and 7 relate to the production of urea particles 10 and Examples 5 and 6 relate to the production of beads made of a ceramic material.

### Example 1

Production of spherical urea particles (10) having a diameter in the range between 2.4 and 2.6 mm:

3 kg of technical urea in powder form were melted batchwise in the storage vessel, here a melting vessel 1. The melting vessel 1 has a steam-heated double shell (not shown). By means of an electrically heated heating cartridge, saturated steam was generated in the outer shell at an overpressure of 1.95 bar which acted as heating medium for melting the urea in the internal vessel. The urea was continuously stirred by means of a slowly running stirrer element 3, here a blade stirrer.

As soon as a melt phase was achieved, the object of the blade stirrer element 3 was homogenizing the melt 2 (starting material that is capable of flow) to achieve a uniform melt phase temperature of about 135.3° C. The relevant physical characteristics of the urea melt are the melt phase density of 1.246 kg/dm³, the surface tension of 66.3 mN/m and the dynamic viscosity of 2.98 mPas at the corresponding melt phase temperature of 135.3° C.

Continuously conducted shaping and stabilizing solidification liquid 11 is circulated via a storage vessel 13 by means of a centrifugal pump 14, via a heat exchanger 15 cooled by a glycol/water mixture, to the instillation apparatus. The cooling brine, glycol/water medium [20% by mass] is conducted by means of a centrifugal pump on the secondary side in a separate cooling circuit via a cooling unit of installed power of 3.2 kW to 0° C. The cooling brine cools not only the storage vessel 13 but also the heat exchanger 15. The cooling area of the heat exchanger 15 was 1.5 m².

As a continuously conducted solidification liquid 11, use is made of an aliphatic hydrocarbon mixture of the type Shell Sol-D-70 [SSD-70]. The solidification liquid 11 has a surface tension of 28.6 mN/m at 20° C. and to this extent is less than that of the urea melt 2 at 66.3 mN/m. The solidification liquid 11 is quasi completely nonpolar and scarcely wetting or nonwetting toward the urea, this means the wetting angle ν>90°.

The density of the solidification liquid 11 at the operating point is 801 kg/m³. The SSD-70 phase was cooled to inlet temperatures of about 0° C. in the instillation apparatus. The throughflow of the nonpolar fluid phase (solidification liquid) was 1.5 m³/h. This is transported into the instillation apparatus by means of a centrifugal pump 14 via the heat exchanger 15.

In the instillation apparatus, the solidification liquid 11 is first conducted vertically upward and calmed via an expanding flow cross section (diffuser), in such a manner that the liquid level set appears visually “planar and smooth” or calm. A smooth instillation surface is present.

In the actual instillation apparatus, the solidification liquid 11 flowed via a specially shaped overflow edge 31 into a duct of width 27 mm and length 220 mm. The overflow edge of the instillation apparatus exhibited a parabolic shape which converts tangentially into the straight part of, the duct which defines the hardening section. This is shown diagrammatically in FIG. 6.

The liquid height set at a flow rate of solidification liquid 11 of about 1.5 m³/h was about 22 mm at the overflow edge, that is at the site at which the solidification liquid 11 is first accelerated under the influence of gravity. The solidification liquid 11 is then conducted away via a laterally restricted duct directed into the storage vessel 13. A fully developed and free-flowing flow is formed in the duct.

At a given operational readiness, this means in the presence of a homogeneous melt phase of the urea at a temperature of about 135.3° C., the vibration system for activating the periodic disturbance force was switched on. The periodically acting disturbance force is harmonic and, via a motion detector, displays a sinusoidal excursion (amplitude) on a HAMEG HM 303-6 type oscilloscope. The excitation frequency was, in the case of producing spherical urea beads in a diameter range between 2.4 and 2.6 mm, 124.6 Hz and was set using the combined frequency generator and amplifier of the TOELLNER TOE 7741 type. The amplitude of the vibration was set on the potentiometer of the instrument (position 2).

After the periodic disturbance force had been set, a shutoff valve was opened in the feed line of the melt phase to the mass proportioner 7 and a mass flow rate of 5.6 kg/h was set by means of a gear pump by varying the frequency-controlled rotary speed. Not only the pump head but also the feed line were externally steam heated. The mass flow rate was indicated using an inductive mass flow meter 109 or controlled subsequently, as control parameter of the rotary speed via a PID hardware controller, in automatic operation.

The defined mass flow rate was fed to the mass proportioner 7, 8, wherein the nozzle diameter was 1.5 mm. The melt phase is excited by the vibration. The flow conditions set correspond to those of laminar jet breakup with resonance excitation. Under these conditions, what is termed a “static” drop pattern was exhibited (FIG. 4) which can be visualized using a stroboscopic lamp of the DrelloScop 3108 R type. The wavelength would be about 5.6 mm after the 7^{th}-8^{th} particle of the drop pattern. In fact, the drop collective was immersed after the 2^{nd} to 3^{rd} particle of the static drop pattern.

The roughly mass-equivalent drops 9 generated by means of resonance excitation of the laminar jet breakup were introduced at an acute angle α of about 75° into the continuously conducted fluid phase (solidification liquid 11). The fluid, SSD-70, exhibited just after the site of instillation a velocity of 1.01 m/s. This corresponded to an Re number of about 260 just after the site of instillation corresponding to the relative velocity between solid particle 10 and fluid (solidification liquid 11). The submerged and subsequently still further sinking solid particles 10 were carried along by the fluid flow and, after their sufficient hardening by cooling; were led off into the fluid storage vessel 13 positioned beneath. In this was situated a sieve basket 12 by which the spherical urea particles 10 could be separated from the fluid phase (solidification liquid 11). Under these conditions, an at first visually observable improvement in the drop shape to give “more spherical” solid particles 10 proceeds after about 100 milliseconds or after about 30% of the pathway covered in the fluid phase (solidification liquid 11), wherein, in addition, the spherically shaped solid particles 10 lost the transparent appearance of the melt phase and appeared opaque.

Under these conditions, urea particles 10 having a sphericity of 0.974 were generated. The particle size distribution of the entire fraction is normally distributed and was between 2.3 and 2.7 mm. About 84.7% by mass of the urea particles 10 produced were in the diameter range of interest between 2.4 and 2.6 mm and exhibited a high density of 1.2947 kg/dm³. With respect to sphericity, a relative diameter deviation of <3.4% is exhibited.

### Example 2

Corresponding to the experimental arrangement described in Example 1, spherical urea particles 10 having a median diameter d₅₀ of about 2.7 mm were produced by varying or increasing the mass flow rate of the melt. In this case, the mass flow rate was increased from previously 5.6 kg/h to 6.6 kg/h.

To improve cooling, in parallel, the addition of the continuously conducted solidification liquid 11 [SSD-70] was also increased from 1.5 to 2 m³/h. The liquid height which was set, at a flow rate of about 2 m³/h, was about 27 mm at the overflow edge, that is at: the site at which the liquid is first accelerated under the influence of gravity.

The approximately mass-equivalent drops 9 produced by means of resonance excitation of the laminar jet breakup were introduced at an acute angle α of about 78° into the continuously conducted solidification liquid 11. The SSD-70, just after the site of instillation, exhibited a velocity of 1.04 m/s. This corresponded to an Re number of about 400 just after the site of instillation, corresponding to the relative velocity between solid particle 10 and fluid (solidification liquid). Under these conditions an at first visually observable improvement in the drop shape to give “more spherical” particles proceeds after about 100 milliseconds or after about ⅓ of the pathway covered in the solidification liquid, wherein, in addition, the spherically shaped solid particles 10 lost the transparent appearance of the melt phase and appeared opaque.

Under these conditions, as solid particles, urea particles (10) having a sphericity of 0.974 were generated. The particle size distribution of the entire fraction is normally distributed and was between 2.5 and 2.9 mm. Around 82.3% by mass of the urea particles 10 produced were in the diameter range of interest between 2.6 and 2.8 mm and exhibited a high density of 1.2953 kg/dm³. With respect to sphericity, a relative diameter deviation of ≦3.7% is exhibited.

### Example 3

Corresponding to the experimental arrangement described in Example 1, spherical urea particles 10 having a median diameter d₅₀ of about 1.9 mm were produced as solid particles. The mass flow rate of the melt was 2.2 kg/h.

Coolant stream [solidification liquid SSD-70] was set to 1.0 m³/h. The liquid height which was set at a flow rate of about 1 m³/h was about 17 mm at the overflow edge, that is at the site at which the liquid is first accelerated under the influence of gravity.

The approximately mass-equivalent drops 9 produced by means of the resonance excitation of the laminar jet breakup were introduced at an acute angle α of about 71° into the continuously conducted solidification liquid 11. The SSD-70 exhibited a velocity of 0.9 m/s just after the site of instillation. This corresponded to an Re number of about 54 just after the site of instillation, corresponding to the relative velocity between particles and fluid. Under these conditions, an at first visually observable improvement in drop shape proceeds to give “more spherical” particles after about 100 milliseconds or after about ⅓ of the pathway covered in the solidification liquid, wherein, in addition, the spherically shaped particles lost the transparent appearance of the melt phase and appeared opaque.

Under these conditions, urea particles 10 having a sphericity of 0.983 were generated. The particle size distribution of the entire fraction is distributed normally and was between 1.7 and 2.1 mm. Around 85% by mass of the urea particles 10 produced were in the diameter range of interest between 1.8 and 2.0 mm and displayed a high density of 1.2957 kg/dm³. With respect to sphericity, a relative diameter deviation of <1.7% is exhibited.

### Example 4

### Rotating Vessel

Production of spherical urea particles having a diameter in the range between 1.8 and 2.0 mm by means of a rotating vessel of FIG. 20. The melt phase (2) was produced in the same manner as set forth in Example 1. This also applies to the physicochemical characteristics of the melt and also the set mass flow rate of 2.2 kg/h.

Instead of the duct channel funnel of Examples 1-3, the rotating vessel (FIG. 20) was connected into the plant. All other plant components were identical to Example 1. The solidification liquid 11 used was again Shell Sol-D-70 [SSD-70] having the physicochemical characteristics set forth in Example 1. The dynamic viscosity of SSD-70 was 2.54 mPas. The density of the solidification liquid at the operating point was 802.7 kg/m³. The SSD-70 phase was cooled to an inlet temperature in the rotating vessel of minus 4.1° C. The throughflow of the solidification liquid was transported into the rotating vessel using a centrifugal pump via the heat exchanger and was 1.5 m³/h.

In the rotating vessel, the solidification liquid 11 is first introduced into the vessel at the lower side via a horizontal inlet nozzle 201. It is thereafter conducted in a riser pipe 205 vertically upward into a cylindrical ring region 203 which is mounted on the inside of a ring-shaped cylinder 204. Via bore holes 205 which are attached in the ring-shaped cylinder 204 over the entire periphery at the height of the cylindrical ring area, the cold solidification liquid 11 passes into the instillation region 206. From here the solidification liquid 11 which is being heated by the instillation of the hot urea melt is forced to flow into the internal region of the ring-shaped cylinder to the bottom or collection region 209 of the rotating vessel. There, the urea particles 10 are separated from the solidification liquid 11 either by gravitation or by a sieve installed there. Thereafter, the warm solidification liquid is discharged from the rotating vessel 208 via an internal funnel 207 and an outlet tube. Owing to this flow conduction, in the instillation region a planar liquid level of cold solidification liquid 11 forms. The rotation of the solidification liquid 11 is effected at the bottom of the vessel 211 by a drive motor via a toothed disk. The heat of crystallization of the urea melt is continuously discharged from the rotating vessel with the solidification liquid 11 and removed via the integrated heat exchanger. The heated solidification liquid 11 is recooled and circulated via the storage vessel 13 and the heat exchanger 15.

The urea melt was dropletized under the same conditions as described under Example 1. The nozzle diameter was 1.0 mm. The drop collective was submerged after the 5^{th} particle of the static drop pattern. The point of entry of the drops into the continuously conducted fluid phase 11 had a distance of 28 mm from the fluid surface to the nozzle in the direction of the nozzle axis (vertically measured distance). The horizontal distance of the site of instillation from the inside of the vessel wall was 40 mm. The radius of the site of instillation, measured from the line of symmetry of the rotating vessel, was 65 mm.

The angular velocity of the vessel was measured at 75 rpm. The approximately mass-equivalent drops (9) generated by means of the resonance excitation of laminar let breakup were introduced into the rotating, level-controlled fluid phase. The fluid, SSD-70, directly at the site of instillation, had a peripheral velocity of 0.51 m/s. This corresponded to an Re number of 156.7 just after the site of instillation, corresponding to the relative velocity between particles and fluid and an Fr number of 5.39. The submerged particles, owing to the force conditions being established on the individual particles resulting from weight, lift, resistance and coriolis force, were passed in a downward-directed, spiral-shaped motion, to the vessel bottom. During this phase the hardening process of the urea particles took place. The hardened urea particles were collected in the collection region 209 and discharged from the rotating vessel discontinuously using the outlet cock 210.

Under these conditions, urea particles 10 having a sphericity of 0.970 were generated. The particle size distribution of the entire fraction is distributed normally and was between 1.7 and 2.1 mm. Around 85.8% by mass of the urea particles 10 produced were in the diameter range of interest between 1.8 and 2.0 mm and exhibited a high density of 1.2952 kg/dm³. With respect to sphericity, a relative diameter deviation of <3.7% is exhibited.

### Example 5

Corresponding to the experimental arrangement described in Example 1, spherical solid particles based on a ceramic (10) having a median diameter d₅₀ of about 0.43 mm were produced as solid particles using the duct channel funnel (FIG. 6).

An aqueous suspension 2 of the oxides of the system CeO₂/ZrO₂ containing 16.3% by mass CeO₂, based on the feed oxides, were, after the wet comminution, admixed with 0.45% by mass of the ceramic binder ammonium alginate. The aqueous suspension was subsequently dispersed using the Ultra Turax D50 dispersing element from IKA, and the ceramic binder was homogenized in the aqueous suspension of the oxides. The dispersed suspension had a residual moisture of 48.5% by mass, a dynamic viscosity of 3.6 dPas and a surface tension of 43.5 mN/m.

For production of spherical ceramic particles in a diameter range between 0.36 and 0.55 mm (after sintering), 1 dm³ of the abovementioned finished suspension was charged into a laboratory stirred vessel of 2 dm³. The finished suspension was continuously stirred by means of a slow running anchor stirrer element 3. The speed of rotation of the stirrer element was 60 rpm.

The hardening, stabilizing and shaping solidification liquid 11 used was an aqueous alcoholic calcium chloride solution. A solidification liquid 11 was produced from two completely mutually miscible substances of different polarity.

The concentration of the component ethanol which was less polar compared with the medium to be dropletized (finished suspension) was 25% by mass. In the ethanolic solution 1% by mass CaCl₂ was dissolved. In this case, a surface tension of 42.5 mN/m of the alcoholic CaCl₂ solution can be measured. This is lower than that of the finished suspension at 43.5 mN/m. The density of the hardening solution was 1.001 kg/dm³.

The solution, as described under Example 1, was transported from the storage vessel via a centrifugal pump, but without cooling circuit, to the mass proportioner. The hardening was performed by divalent calcium ions in combination with the added ceramic binder ammonium alginate.

The vibration system, as described under Example 1, was activated. The frequency of excitation was 334.5 Hz and the amplitude setting was 1.5. A mass flow rate of 0.36 kg/h was set on the rotary-speed-controlled centrifugal pump. The nozzle diameter was 0.3 mm. The flow conditions set corresponded to those of laminar jet breakup with resonance excitation.

The liquid height set, at a flow of solidification liquid 11 of about 2 m³/h, was, at the overflow edge, that is at the site at which the liquid is for the first time accelerated under the influence of gravity, about 18 mm.

The approximately mass-equivalent drops 9 generated by means of resonance excitation of the laminar jet breakup were introduced into the continuously conducted solidification liquid 11 at an acute angle α of about 72°. The solidification liquid 11 was an ethanolic CaCl₂ solution having a velocity of 0.90 m/s at the site of instillation. This corresponded to an Re number of about 45.

The hardening of the spherical particles proceeds in this example by ion exchange between the Ca²⁺ ions present in the hardener solution and the ammonium ion situated in the suspension. Owing to the nonpolar fraction of the hardener solution, this being the ethanol, the hardening does not proceed abruptly, but again after about ⅓ of the path covered of the hardener section successively from the outside to the inside by gelation.

Under these conditions, ceramic particles having a sphericity of 0.991 after drying and sintering were generated. The particle size distribution of the entire fraction is distributed normally and, after subsequent drying and sintering, was between 0.33 and 0.56 mm. Around 92.7% by mass of the ceramic particles produced were in the diameter range of interest between 0.36 and 0.5 mm. The d₅₀ was 0.43 mm and the spherical particles exhibited a high density of 6.18 kg/dm³. The sphericity showed a relative diameter deviation of <0.3%.

### Example 6

As instillation apparatus, that of FIG. 27 is connected into the experimental plant, instead of the duct channel funnel (FIG. 6). The suspension used was that produced under Example 5 and the physicochemical characteristics and also the settings of the mass proportioner were identical to Example 5. Solid particles 10 based on a ceramic having a median diameter d₅₀ of about 0.43 mm were produced using the 2-phase instillation apparatus (FIG. 27).

The upper, lighter and nonpolar phase of the solidification liquid 11 used was SSD-70 at about 15° C. having a density of 0.788 kg/dm³. The stabilizing and shaping task falls to this phase. The phase height of the SSD-70 was 140 mm. As hardening phase of the solidification liquid 11, 3 Ma % of calcium chloride were dissolved in a 93.6 Ma % purity ethanol solution (technical quality). This phase exhibits a density of 0.833 kg/dm³ and formed a layer under the SSD-70 phase. As a result of the high EtOH content of the heavier phase, firstly a low interfacial surface tension between the two immiscible fluid phases SSD-70/CaCl₂-EtOH of 2.7 mN/m is set at 20° C. and secondly the chemical hardening in the heavier phase is delayed. The fluid height of the heavier phase was 1.6 m. The surface tension of the SSD-70 phase was 28.6 mN/m, that of the suspension was 43.5 mN/m.

The green beads are separated off from the heavier phase of the solidification liquid 11 in a cone or via a sieve 12. Under these conditions, ceramic particles having a sphericity of 0.992 were generated after drying and sintering were performed. The particle size distribution of the entire fraction is distributed normally and, after subsequent drying and sintering, was between 0.33 and 0.56 mm. Around 94.5% by mass of the ceramic particles produced were in the diameter range of interest between 0.36 and 0.5 mm. The d₅₀ was 0.43 mm, and the spherical particles exhibited a high density of 6.22 kg/dm³ after sintering. The sphericity exhibits a relative diameter deviation of <0.3%.

### Example 7

In a further embodiment, the urea particles 10 according to the invention are produced by a two-stage method which is described hereinafter merely by way of example:

a) first formation of liquid urea bead,
b) then stabilization of the bead shape and hardening.

For formation of a liquid urea bead, in this embodiment a dropletization method is used. In this case, with high constancy, very small and extremely small urea particles 10 of approximately bead shape are generated. The larger the diameter of the urea beads, the more difficult it is to obtained good sphericity.

FIG. 5 shows the fundamental makeup of a dropletizing unit. Urea melt 2 in this case is forced through a nozzle 7, wherein the nozzle 7 is vibrated S.

As a result of the nozzle shape in combination with suitable fluid mechanics characteristics (see above for example values), in the nozzle 7 a laminar flow is set, corresponding to the physicochemical characteristics of the urea system.

The urea melt is quasi dropletized after the nozzle orifice 2; bead-shaped urea drops 9 are formed. The harmonic vibration force imposed on the urea melt corresponds to the first harmonic of the urea system. In this case an amplitude of 2.5 mm is set. The frequency of the vibration was 124 Hz. The temperature of the melt was about 136° C.

The vibration force imposed on the urea melt effects what is termed laminar jet breakup which favors the constancy of mass of the beads. With the aid of the harmonic vibration, a type of intended weak spot in the urea melt jet is caused, in such a manner that quasi same-sized urea particles 10 always form (volume proportioning). In this case, to the motive force of detachment and the weight force, is added the vibration force. The retaining forces in this case are the surface tension force and the lift force which counteract the resultant detachment force.

By increasing the frequency (for example second harmonic), at the same volume flow rate and nozzle diameter, somewhat smaller drops 9 can be generated.

An optimally set dropletization with superimposed vibration is revealed in what is termed a static drop pattern which is shown in FIG. 4. In this case, the drop distribution quasi corresponds to a monomodal distribution.

Since the bead or the drop 9 already has a correspondingly high velocity, it is situated just before the steady state velocity of free fall. It is necessary particularly to ensure that the beads on impact onto a boundary surface are not again deformed or divided. Corresponding to the experiment, the second to fifth bead of the standing wave shows the best bead shape and to this extent, from this time point or position, sheath stabilization by rapid cooling should be introduced.

Some essential features of the method step for stabilizing the bead shape owing to the relatively large diameter are:

reduction of the destructive reaction force of the liquid by introducing the urea bead at an acute angle (see, for example, description for FIG. 3, 6).

putting the bead into an advantageous shaping supporting rotation motion or inherent rotation by the cross-flowing liquid.

reducing the relative velocity between urea bead and solidifying medium, in particular a cooling medium, either by varying the instillation height or the falling height of the liquid, so that the disturbing flow force is vertically minimized.

Rapid heat removal with targeted cooling with correspondingly conducted coolant phase.

Reduction of the interfacial surface tension force by using a nonpolar coolant (solidification liquid 11) such as SSD-70. In general, nonpolar fluid coolants are possible.

The advantageous utilization of the nonpolar (coolant) and polar (urea) interaction forces leads to the fact that the system has a tendency to form the minimum surface area with respect to volume. This is the bead shape.

It is also possible to carry out “smooth” introduction of the urea drops 9 or beads in a whirlpool. Also, instillation into a funnel with appropriate angle and overflowing cooling liquid of corresponding thickness and flow has the same effect.

The urea particles 10 produced by one embodiment of the method of the invention have been analyzed.

Using a Camsizer from Retsch Technology, studies were made on experimental batches of particles according to one embodiment of the invention, of which batch 0001 was selected.

Analysis with the instrument was performed according to particle classes (diameter in mm). In Table 3, the properties of the urea beads 10 are listed.

The fracture strength of the embodiments of the particles compared with urea technically prilled not conditioned was measured using a tablet fracture strength tester TBH 300 S from ERWEKA. The fracture strength is given in the dimension of the force which is required to fracture a particle between two parallel plates and is related to the particle cross section in the equatorial plane of the urea particle 10.

For a urea particle 10 having a median diameter of 2.5 mm, measurement of the fracture force gave the following results:

| | |
|---|---|
| Urea technically prilled: | 7.8 N |
| Urea samples according to the invention | 12.7 N |
| | 12.2 N |

It is thus shown that the urea particles 10 produced have virtually twice as high a fracture strength as prilled urea particles.

In addition, using Hg porosimetry as specified in DIN 66 133 via measurement of the volume of mercury pressed into a porous solid as a function of the pressure used, the pore volume, the specific surface area, the mean pore radius and the porosity were measured. In addition, the apparent particle density was measured as specified in the standard EN 993-17 using mercury displacement under vacuum conditions. The apparent density has approximately the same value as the density of the base material. The difference occurs as a result of the pores and closed cavities into which the mercury cannot penetrate (g/cm³).

The measurements gave the pattern as in Table 4.

In this case it is found that the mean pore radius of the urea particles 10 according to the invention is lower by about 2 powers of ten than that of the known particles. Also, the specific surface area is significantly greater than that of the known urea particles.

In one embodiment, the urea particles 10 are used in the selective catalytic reduction (SCR) of nitrogen oxides in a motor vehicle.

For reducing nitrogen oxides, SCR is a suitable measure (see Bosch, Kraftfahrtechnisches Taschenbuch [Automotive engineering handbook] 25th edition, 2003, p. 719).

SCR is based on the fact that ammonia in the presence of a selective catalyst reduces nitrogen oxides to nitrogen and water. In the present application in a motor vehicle, the nitrogen oxides NO are catalytically reduced to N₂ and H₂O by the NH₃ released from the urea.

### Hydrolysis Reaction of Urea:

(NH₂)₂CO+H₂ [symbol] 2NH₃+CO₂

### Selective Catalytic Reduction (SCR)—Reaction of Nitrogen Oxides:

4NH₃+4NO+O₂ [symbol] 4N₂+6H₂O

8NH₃+6NO₂ [symbol] 7N₂+12H₂O

It is known that urea in aqueous solution is injected into the exhaust gas stream. The urea solution (a 32.5% strength solution) is used in this case because of its good meterability.

The urea particles 10 are so uniform, that is they possess such a narrow tolerance for their mass, that the uniformity of metering can also be achieved with the urea particles 10 according to the described embodiments instead of with a liquid solution. Owing to the significantly higher active compound concentration compared with the aqueous solution (32.5%) and owing to their much smaller volume, the solid particles make possible more favorable transport and storage conditions.

With respect to introducing the particles into the exhaust gas stream in SCR, there are various methods, firstly by direct metering and fine distribution of the urea in the exhaust gas stream, secondly by pyrolytic gasification of the urea and metering the gases into the exhaust gas stream.

Use of the urea particles 10 according to the invention is not restricted to the SCR technique, rather any other technical fields of application are also conceivable.

All above-described embodiments or parts thereof can also be combined with one another.

### LIST OF REFERENCE SIGNS

1 storage vessel
2 starting material that is capable of flow
3 stirrer element
4 constant fluid level pump
6 mass flow meter
7 mass proportioner/nozzle
8 electronically controlled electromagnet
9 drop
10 solid particle
11 solidification liquid
12 mechanical separation unit
13 storage vessel for solidification liquid
14 centrifugal pump
15 heat exchanger
20 two-component nozzle
21 cooling medium for precooling, aerosol (spray mist)
30 inlet for solidification liquid
31 overflow weir, flow impedance body, flight flow impedance body
40 perforated plate
41 reservoir for starting material
42 nozzle
43 wall
44 feed line for starting material that is capable of flow
50 movement track of the drops (9)
60 stirred tank
61 whirlpool or whirlpool shape
62 cooling jacket of the stirred tank 60
63 stirrer element, adjustable in height and rotary speed
64 rotary speed controller, frequency transformer
101 storage vessel, starting material that is capable of flow
102 fluid level
103 pump
104 mass proportioner
105 constant fluid level
106 control or float valve
107 pressure controller
108 pressurizing gas
109 mass flow meter
201 feed line, rotating vessel, sliding ring seal
202 riser line, solidification liquid
203 distribution device solidification liquid fresh or cold
204 distribution device arranged in a ring shape, solidification liquid
205 hole of the distribution device
206 fluid level, instillation region
207 internal funnel for draining off “used” or heated solidification liquid
208 outlet tube used or heated solidification liquid
209 collecting cone for spherical solid particles (10)
210 outlet shutoff element, bead outlet
211 rotary motion, toothed belt disk motor (simplified or not shown)
301. feed line solidification liquid, closed system
302. distributor
303. tangentially arranged inlet tubes
304. ring channel formed in a ring shape
305. movement track of the solid particles (10) helical
306. outlet tube used or heated solidification liquid including spherical solid particle.
307. collecting cone for spherical solid particles (10) and separating device.
308. outlet shutoff element, bead outlet.
PIC pressure regulator
CV control valve
WIC mass flow rate controller
M motor
FIC flow measurement

TABLE 1

| | | | | | Cumulative |
|---|---|---|---|---|---|
| | | | Pore | Cumulative | proportion |
| | | Pore | volume | Pore | Pore |
| Class of pore | | volume | Proportion | volume | volume |
| radii in nm | | mm³/g | in % | in mm³/g | in % |
| 1 | 5 | 10.09 | 20.93 | 10.09 | 20.93 |
| 5 | 10 | 9.93 | 20.60 | 20.02 | 41.53 |
| 10 | 20 | 4.70 | 9.76 | 24.73 | 51.28 |
| 20 | 50 | 3.30 | 6.85 | 28.03 | 58.14 |
| 50 | 100 | 0.96 | 1.99 | 28.99 | 60.13 |
| 100 | 500 | 4.00 | 8.31 | 32.99 | 68.44 |
| 500 | 1000 | 2.08 | 4.32 | 35.08 | 72.75 |
| 1000 | 5000 | 3.21 | 6.65 | 38.28 | 79.40 |
| 5000 | 10 000 | 1.60 | 3.32 | 39.88 | 82.73 |
| 10 000 | 50 000 | 7.37 | 15.28 | 47.25 | 98.01 |
| 50 000 | 100 000 | 0.96 | 1.99 | 48.21 | 100.00 |
| Sum of | | 48.21 | | | |
| pore | | | | | |
| volumes: | | | | | |

TABLE 2

| Range | Volume | Relative volume |
|---|---|---|
| [nm] | [mm³/g] | [%] |
| 60 000-2000 | 12.25 | 25.89 |
| 2000-60 | 7.47 | 15.79 |
| 60-2 | 27.60 | 58.32 |

TABLE 3

| | | | Propor- | | | Volume | Volume | Mass ***) | Mass ***) |
|---|---|---|---|---|---|---|---|---|---|
| | Particle | | tion | Sphe- | | mm³ | mm³ | mg | mg |
| | class *) | | % | ricity | B/L **) | min. | max. | min. | max. |
| Batch | 1.000 | 2.000 | 0.00 | | | | | | |
| 0001 | 2.000 | 2.400 | 7.42 | 0.970 | 0.910 | 4.187 | 7.235 | 5.401 | 9.333 |
| | 2.400 | 2.500 | 38.10 | 0.973 | 0.930 | 7.235 | 8.177 | 9.333 | 10.548 |
| | 2.500 | 2.600 | 44.31 | 0.974 | 0.942 | 8.177 | 9.198 | 10.548 | 11.866 |
| | 2.600 | 2.700 | 9.59 | 0.972 | 0.948 | 9.198 | 10.301 | 11.866 | 13.288 |
| | 2.700 | 2.800 | 0.45 | 0.972 | 0.942 | 10.301 | 11.488 | 13.288 | 14.820 |
| | 2.800 | 2.900 | 0.13 | 0.974 | 0.946 | 11.488 | 12.764 | 14.820 | 16.465 |
| | 2.900 | 3.000 | 0.00 | | | | | | |
| | 3.000 | 4.000 | 0.00 | | | | | | |

*) Classification according to min. Feret diameter
**) B/L = min. Feret diameter [mm]/max. Feret diameter [mm]
***) Mass = volume [mm³] × apparent particle density (d = 1.29 [g/mm³])

TABLE 4

| | | Particle |
|---|---|---|
| | | according to the |
| Measurement | Unit | invention |
| Pore volume | (mm³/g) | 48.21 |
| Specific surface area | (m²/g) | 10.83 |
| Mean pore radius*) | (nm) | 16.5 |
| Porosity | (%) | 6.23 |
| Apparent particle density | (g/cm³) | 1.29 |

*)Mean pore radius = pore radius at 50% of the cumulative pore volume.

1-102. (canceled)

103. A method for producing solid particles from a starting material that is capable of flow, wherein
a) the starting material that is capable of flow is dropletized and
b) the drops are introduced along a movement track into a solidification liquid in which they are solidified to form the solid particles, and use is made of a solidification liquid, wherein, in the event that the starting material that is capable of flow contains actinide oxides, the solidification liquid is designed to be flowing and
c) the surface tension of the solidification liquid is lower than the surface tension of the starting material that is capable of flow.

104. The method as claimed in claim 103, wherein use is made of a solidification liquid, the surface tension of which is less than 50 mN/r, in particular less than 30 mN/m.

105. The method as claimed in claim 103, wherein the interfacial surface tension between the material of the drops and the solidification liquid is between 25 and 50 mN/m, in particular between 30 and 50 mN/m, very particularly between 35 and 50 nN/m.

106. The method as claimed in claim 103, wherein a solidification liquid is selected in such a manner that the contact angle or wetting angle between the starting material that is capable of flow and the solidification liquid is >45°, and particularly preferably >90°.

107. The method as claimed in claim 103, wherein as solidification liquid for a polar starting material that is capable of flow, a nonpolar medium is used, in particular an aliphatic high-boiling hydrocarbon, an unsaturated hydrocarbon, an aromatic hydrocarbon, a cyclic hydrocarbon, a halogenated hydrocarbon and/or a hydrocarbon having at least one keto group, at least one ester group, at least one aldehyde group, which has or consists of a mixture of at least two hydrocarbons, in particular an aliphatic mixture.

108. The method as claimed claim 103, wherein a reduction in surface tension or interfacial surface tension of the solidification liquid is achieved, in particular with surfactants, wherein, for example, as tension-reducing substances, the chemical functional classes of alkyl/aryl sulfates, alkyl/aryl sulfonates, alkyl/aryl phosphates, alkyl/aryl fluorates, alkyl/aryl ethoxylates, ethers, oxazolidines, pyridinates, or succinates are usable.

109. The method as claimed in claim 103, wherein, at the site of introduction of the drops, there is a relative velocity between the drops and the solidification liquid.

110. The method as claimed in claim 103, wherein, for starting materials which are capable of flow and which contain ceramic materials, the solidification liquid is designed to be flowing.

111. The method as claimed in claim 103, wherein the drops are introduced into a pronounced longitudinal or rotating flow of the solidification liquid.

112. The method as claimed in claim 103, wherein the instillation is performed at an angle α≦90°, in particular at an acute angle of less than 90°, wherein the angle α is between the tangent to the movement tracks of the drops and the tangent to the surface of the solidification liquid, in each case plotted at the site of instillation into the solidification liquid, in particular the flowing solidification liquid.

113. The method as claimed in claim 103, wherein the solidification liquid in particular in an embodiment as coolant, serves for conditioning.

114. The method as claimed in claim 103, wherein the starting material that is capable of flow is dropletized by a laminar jet breakup by exposing a laminar jet of the starting material that is capable of flow to a foreign excitation, in particular a resonance excitation.

115. The method as claimed in claim 103, wherein between the solid particles and the solidification liquid, laminar flow conditions are established having an Re number of 0.5 to 500 and a Froude number between 0.1 and 10, particularly less than 5, and very particularly less than 2, wherein the dimensionless numbers are related to the state around the site of instillation.

116. The method as claimed in claim 103, wherein in particular the resonance excitation of the laminar jet, is formed in such a manner that the drops give a static drop pattern one below the other.

117. The method as claimed in claim 103, wherein as starting material that is capable of flow, use is made of a melt, in particular a polymer melt, a thermally unstable melt, a urea-containing melt or a urea melt.

118. The method as claimed in claim 103, wherein as starting material, use is made of a suspension that is capable of flow and which contains a ceramic material and a binder.

119. The method as claimed in claim 118, wherein for the solidification of the suspension containing the ceramic material, a chemical hardening is employed.

120. The method as claimed in claim 103, wherein the solidification liquid has at least two immiscible or only poorly mutually miscible phases of different density, interfacial surface tension, polarity and/or surface tension.

121. The method as claimed in claim 120, wherein the interfacial surface tension between the two phases of the solidification liquid is less than or equal to 10 mN/m.

122. A urea particle, with
a) a sphericity of ≧0.923,
b) an apparent particle density, in particular a median apparent particle density, in the range between 1.20 and 1.335 g/cm³ and
c) a diameter between 20 μm and 6000 μm, at a relative standard deviation of <10%.

123. A urea particle, with
a) an apparent particle density, in particular a median apparent particle density, of the urea particle in the range between 1.25 and 1.33 g/cm³, and
b) a median minimum Feret diameter of the urea particles in the range between less than or equal to 4 mm, in particular between 1.2 and 3.5 mm, in particular between 1.4 and 3.2 mm, having a respective relative standard deviation of less than or equal to 5%, and
c) a ratio of minimum Feret diameter to maximum Feret diameter of the urea particles of greater than or equal to 0.92 for a diameter of the urea particles of 2400 to 2600 μm, of greater than or equal to 0.90 for a diameter of the urea particles of 1800 to 2000 μm, of greater than or equal to 0.87 for a diameter of the urea particles of 1400 to 1600 μm, of greater than or equal to 0.84 for a diameter of the urea particles of 1100 to 1300 μm.

124. The urea particle as claimed in claim 123, the urea particle having a median minimum Feret diameter in the range between 1.2 and 3.5 mm, in particular between 1.4 and 3.2 mm, with a relative standard deviation of less than or equal to 4%.

125. The urea particle as claimed in claim 123, the urea particle having a median minimum Feret diameter in the range between 2.4 and 2.6 mm or 1.8 and 2.0 mm or 1.4 and 1.6 mm or 1.1 and 1.3 mm with a relative standard deviation of less than or equal to 3.5%.

126. The urea particle as claimed in claim 122, the urea particle having a diameter between 1000 μm and 4000 μm,
preferably between 1000 μm and 3200 μm,
preferably between 1100 μm and 3000 μm,
preferably between 1500 μm and 3000 μm, and
in particular preferably between 1100 to 1300 μm or 1400 to 1600 μm or 1800 to 2000 μm or 2400 to 2600 μm, in each case at a relative standard deviation of ≦10%, preferably ≦5%, preferably ≦4%, in particular ≦3.5%.

127. The urea particle as claimed in claim 122, the urea particle having a sphericity of ≧0.923, in particular ≧0.940, in particular ≧0.950, in particular ≧0.960, in particular ≧0.970, very particularly ≧0.980.

128. The urea particle as claimed in claim 122, wherein a ratio of minimum Feret diameter to maximum Feret diameter of the urea particles is greater than or equal to 0.923.

129. The urea particle as claimed in claim 122, the urea particle having an apparent particle density, in particular a median apparent particle density, between 1.250 and 1.335 g/cm³.

130. The urea particle as claimed in claim 122, wherein the urea particle has a finely crystalline outer sheath.

131. The urea particle as claimed in claim 122, the urea particle having a pore distribution having a cumulative pore volume fraction of greater than or equal to 50% of pores having a radius less than or equal to 1000 nm measured as specified in DIN 66133.

132. The urea particle as claimed in claim 122, the urea particle having a pore distribution having a cumulative pore volume fraction of greater than or equal to 45% of pores having a radius less than or equal to 50 nm measured as specified in DIN 66133.

133. The urea particle as claimed in claim 122, the urea particle having a mean pore radius of less than 25 nm.

134. The urea particle as claimed in claim 122, the urea particle having a sum fraction of alkali metals of less than or equal to 0.75 mg/kg, in particular of less than or equal to 0.50 mg/kg.

135. The urea particle as claimed in claim 122, the urea particle having a phosphate fraction of less than or equal to 0.5 mg/kg, in particular of less than or equal to 0.2 mg/kg.

136. The urea particle as claimed in claim 122, with a constancy of mass having a relative standard deviation of <18%, in particular of <15%, in particular of <12%, in particular of <10%, measured on a collective of 1000 urea particles.

137. The urea particle as claimed in claim 122, with a maximum crystallite size of less than or equal to 20 μm, particularly less than or equal to 1 μm, in particular less than or equal to 0.1 μm, very particularly with an amorphous structure.

138. The urea particle as claimed in claim 122, with a fracture strength distribution in which 10% have a fracture strength of greater than 1.4 MPa, 50% have a fracture strength of 2.2 MPa and 90% have a fracture strength of 2.8 MPa.

139. The urea particle as claimed in claim 122, with a sum fraction of alkaline earth metals of less than or equal to 1.0 mg/kg, in particular less than or equal to 0.7 mg/kg.

140. The urea particle as claimed in claim 122, with a sulfur fraction of less than or equal to 2.0 mg/kg, in particular less than or equal to 1.5 mg/kg, very particularly less than or equal to 1.0 mg/kg.

141. A particle made of a ceramic material, with
a. a sphericity of >0.930,
b. a diameter between 20 μm and 6000 μm, at a relative standard deviation of ≦10%.

142. The particle as claimed in claim 141, with a diameter between 100 μm and 2500 μm, in each case at a relative standard deviation of ≦5%, preferably ≦4%, in particular ≦1%.

143. The particle as claimed in claim 141, wherein the ceramic material is a cerium-stabilized zirconium oxide having a CeO₂ content of 10 to 30% by mass.

144. The particle as claimed in claim 141 with a sphericity of ≧0.960, in particular of ≧0.990.

145. The particle as claimed in claim 141, with a diameter between 300 μm and 2000 μm, at a relative standard deviation of ≦3.5%.

146. The particle as claimed in claim 145, with an apparent particle density in the range between 6100 and 6250 g/cm³.

147. A device for producing solid particles from a starting material that is capable of flow, the device having
(a) a mass proportioner for generating drops from a starting material that is capable of flow, and
(b) a means for generating an instillation surface of a solidification liquid for the drops,
wherein the solidification liquid has a surface tension which is less than the surface tension of the starting material that is capable of flow.

148. The device as claimed in claim 147, wherein the means for generating an instillation surface has an inclined member, a funnel, a duct channel, a rotating vessel, a rotating liquid due to pump transport or a whirlpool for the solidification liquid.

149. The device as claimed in claim 147, having a means for generating a relative motion between the mass proportioner, in particular a nozzle, a perforated sheet or a capillary, and the solidification liquid.

150. The device as claimed in claim 147, having a means for instilling the drops at an angle α≦90°, in particular at an acute angle of less than 90°, wherein the angle α is between the tangent to the movement tracks of the drops and the tangent to the surface of the solidification liquid, in each case plotted at the site of instillation into the solidification liquid, in particular the flowing solidification liquid.

151. The device as claimed in claim 147, having at least one of means for resonance excitation of a laminar jet of the starting material that is capable of flow or a means for guiding the laminar jet, in particular a mass proportioner.

152. The device as claimed in claim 147, having a reservoir for the starting material that is capable of flow having a perforated plate, wherein the starting material that is capable of flow can be transported to nozzles of the perforated plate by a gravitational force or centrifugal force or both acting on it.
